(19) United States
(12) Patent Application Publication
(10) Pub. No.: US 2025/0330877 A1
(43) Pub. Date: Oct. 23, 2025

(54) METHODS, DEVICES, AND MEDIUM FOR COMMUNICATION

(71) Applicant: NEC Corporation, Tokyo (JP)

(72) Inventor: Gang WANG, Beijing (CN)

(73) Assignee: NEC Corporation, Tokyo (JP)

(21) Appl. No.: 18/868,858

(22) PCT Filed: May 31, 2022
(86) PCT No.: PCT/CN2022/096475

§ 371 Date: Nov. 25, 2024

(51) Int. Cl. H04W 28/16

(52) U.S. Cl. CPC H04W 28/16

(57) ABSTRACT

Example embodiments of the present disclosure relate to methods, devices, and computer storage medium for U2U relay. A second terminal device receives, from a first terminal device, first configuration information indicating at least one of: a first reconfiguration for a first channel between the second terminal device and a third terminal device, or at least one quality of service (QoS) parameter for the first channel; transmits, to the third terminal device, second configuration information determined based on the first configuration information; and transmits, to the first terminal device, configuration feedback information at least indicating whether the first reconfiguration is failed. In this way, the first terminal device may be aware of the reconfiguration state for the first channel, some further operations may be performed by the first terminal device and the communication efficiency can be improved.

### FIELD

Example embodiments of the present disclosure generally relate to the field of communication techniques and in particular, to methods, devices, and a computer readable medium for communication.

### BACKGROUND

Several technologies have been proposed to improve communication performances. For example, sidelink communication has been proposed. Sidelink is a feature aiming at enabling device-to-device (D2D) communications. Unlike uplink or downlink, sidelink enables a direct communication between proximal user equipments (UEs), and data does not need to go through network devices. Relay has also been introduced to enhance the coverage area of a network device by improving the throughput of a UE that is located in the coverage or far from the network device. A UE (called relay UE) can provide other UEs (called remote UEs) that could experience coverage problems with connectivity. The UE-to-Network relay effectively extends network coverage by relaying traffic between the network and remote UEs.

A remote UE (also referred to as source UE here) may communicate with another remote UE (also referred to as destination UE here) via a relay UE. A connection may be established between the source UE and the relay UE via sidelink and also a connection may be established between the relay UE and the destination UE via sidelink.

A message transferred between the source UE and the destination UE via the relay UE is called as an end-to-end (E2E) PC5-signalling (PC5-S) message, and a message transferred between the source UE and the relay UE or between the relay UE and the destination UE is called as a per-hop PC5-S message. Both the E2E PC5-S message and the per-hop PC5-S message may need to be supported in UE-to-UE (U2U) relay communications.

### SUMMARY

In general, example embodiments of the present disclosure provide methods, devices and a computer storage medium for communication. Embodiments that do not fall under the scope of the claims, if any, are to be interpreted as examples useful for understanding various embodiments of the disclosure.

In a first aspect, there is provided a method of communication. The method comprises: receiving, at a second terminal device and from a first terminal device, first configuration information indicating at least one of: a first reconfiguration for a first channel between the second terminal device and a third terminal device, or at least one quality of service (QOS) parameter for the first channel; transmitting, to the third terminal device, second configuration information determined based on the first configuration information; and transmitting, to the first terminal device, configuration feedback information at least indicating whether the first reconfiguration is failed.

In a second aspect, there is provided a method of communication. The method comprises: transmitting, at a first terminal device and to a second terminal device, first configuration information indicating at least one of: a first reconfiguration for a first channel between the second terminal device and a third terminal device, or at least one quality of service (QOS) parameter for the first channel; and receiving, from the second terminal device, configuration feedback information at least indicating whether the first reconfiguration is failed.

In a third aspect, there is provided a method of communication. The method comprises: transmitting, at a first terminal device and to a third terminal device, first configuration information indicating: an end-to-end (E2E) configuration for bearer between the first terminal device and the third terminal device, and a first reconfiguration for a first channel between a second terminal device and the third terminal device; and receiving, from the third terminal device, first configuration feedback information indicating at least one of: whether the first reconfiguration is failed, or whether the E2E configuration is failed.

In a fourth aspect, there is provided a method of communication. The method comprises: receiving, at a third terminal device and from one of a first terminal device and a second terminal device, configuration information indicating a first reconfiguration for a first channel between the second terminal device and the third terminal device; and transmitting, to the one of the first terminal device and the second terminal device, configuration feedback information.

In a fifth aspect, there is provided a second terminal device. The second terminal device comprises a processor and a memory. The memory is coupled to the processor and stores instructions thereon. The instructions, when executed by the processor, cause the second terminal device to perform the method according to the first aspect above.

In a sixth aspect, there is provided a first terminal device. The first terminal device comprises a processor and a memory. The memory is coupled to the processor and stores instructions thereon. The instructions, when executed by the processor, cause the first terminal device to perform the method according to the second or the third aspect above.

In a seventh aspect, there is provided a third terminal device. The third terminal device comprises a processor and a memory. The memory is coupled to the processor and stores instructions thereon. The instructions, when executed by the processor, cause the third terminal device to perform the method according to the fourth aspect above.

In an eighth aspect, there is provided a computer readable medium having instructions stored thereon, the instructions, when executed on at least one processor, causing the at least one processor to carry out the method according to the first aspect, the second aspect, the third aspect or the fourth aspect above.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates a schematic diagram of an example communication network in which some embodiments of the present disclosure can be implemented;

FIG. 2A illustrates a schematic diagram of a control plane protocol stack for a SCCH for radio resource control (RRC) which can be used in some example embodiments of the present disclosure;

FIG. 2B illustrates a schematic diagram illustrating a control plane protocol stack for SCCH for PC5-S which can be used in some example embodiments of the present disclosure;

FIG. 3A illustrates a schematic diagram of an E2E user plane protocol stack which can be used in some example embodiments of the present disclosure;

FIG. 3B illustrates a schematic diagram of an E2E control plane protocol stack which can be used in some example embodiments of the present disclosure;

FIG. 3C illustrates a schematic diagram illustrating a general control plane procedure for U2U relay which can be used in some example embodiments of the present disclosure;

FIG. 4A illustrates a schematic diagram illustrating PC5 quality of service (QOS) flow for vehicle to everything (V2X) in which some embodiments of the present disclosure can be implemented;

FIG. 4B illustrates an example one-to-one mapping of PQI values to PC5 QoS characteristics in which some embodiments of the present disclosure can be implemented;

FIGS. 5A-5H illustrate some examples of configuring scenarios in which some embodiments of the present disclosure can be implemented;

FIG. 6 illustrates a signalling chart illustrating configuring process in accordance with some embodiments of the present disclosure;

FIGS. 7A-7D illustrate signalling chart illustrating processes for determining the first reconfiguration information for the second hop by the first terminal device in accordance with some embodiments of the present disclosure;

FIG. 8 illustrates an example process for determining the transmitting manner according to some example embodiments of the present disclosure;

FIG. 9 illustrates a signalling chart illustrating configuring process according to some example embodiments of the present disclosure;

FIG. 10 illustrates a signalling chart illustrating configuring process according to some example embodiments of the present disclosure;

FIG. 11 illustrates a signalling chart illustrating configuring process according to some example embodiments of the present disclosure;

FIG. 12 illustrates a signalling chart illustrating configuring process according to some example embodiments of the present disclosure;

FIG. 13 illustrates a signalling chart illustrating configuring process according to some example embodiments of the present disclosure;

FIG. 14 illustrates a signalling chart illustrating configuring process according to some example embodiments of the present disclosure;

FIG. 15 illustrates a signalling chart illustrating configuring process according to some example embodiments of the present disclosure;

FIG. 16 illustrates a signalling chart illustrating configuring process according to some example embodiments of the present disclosure;

FIG. 17 illustrates a flowchart of an example method in accordance with some embodiments of the present disclosure;

FIG. 18 illustrates a flowchart of an example method in accordance with some embodiments of the present disclosure;

FIG. 19 illustrates a flowchart of an example method in accordance with some embodiments of the present disclosure;

FIG. 20 illustrates a flowchart of an example method in accordance with some embodiments of the present disclosure; and

FIG. 21 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “terminal device” refers to any device having wireless or wired communication capabilities. Examples of terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also be incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The terminal device or the network device may have Artificial intelligence (AI) or machine learning capability. It generally includes a model which has been trained from numerous collected data for a specific function, and can be used to predict some information.

The terminal device or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network device under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, or channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

In the context of the present disclosure, the term “PC5 connection” may be used interchangeably with PC5-RRC connection, PC5 unicast link, layer-2 link or layer-2 unicast link. The term “E2E” may be used interchangeably with UE-to-UE (U2U) or peer UE. The term “relay UE” may be used interchangeably with UE-to-network relay UE, UE-to-network relay, U2U relay UE, E2E relay UE, U2U relay, E2E relay, or relay device. The term “source UE” may be used interchangeably with Src. UE, TX UE, initiating UE or source device. The term “destination UE” may be used interchangeably with Dest. UE, RX UE, target UE, peer UE or destination device.

In the context of the present disclosure, the term “upper layer” may be used interchangeably with proximity-services (ProSe) layer, vehicle-to-everything (V2X) layer, non-access stratum (NAS) layer or PC5-S layer. The term “lower layer” may be used interchangeably with access stratum (AS) layer, radio resource control (RRC) layer, packet data convergence protocol (PDCP) layer, radio link control (RLC) layer, medium access control (MAC) layer, layer-2 or layer 2. The term “ProSe” may be used interchangeably with proximity based services or proximity services.

The term “adaptation layer identity (ID) for UE” may be used interchangeably with UE ID in adaptation layer, path ID, link ID, or information identifying source UE in adaptation layer. The term “discovery message” may be used interchangeably with direct communication request message or direct link establishment request message. The term “a message over a sidelink interface” may be used interchangeably with PC5 signalling message or PC5-S message.

As mentioned above, both an E2E PC5-S message and a per-hop PC5-S message may need to be supported in the U2U relay communications, but how to configure the E2E PC5-S message and the per-hop PC5-S message needs to be further developed. More generally, in case the TX UE transmits the per-hop PC5-S message, the TX UE is not aware of whether the per-hop configuration is failed.

Embodiments of the present disclosure provide a solution of communication for U2U relay. In the solution, a relay UE may receive first configuration information to configure a second hop and transmit configuration feedback information to the TX UE. As such, the TX UE may be aware of at least whether the second hop is successfully configured. And the TX UE may perform further operations based on the configuration feedback information and thus the communication efficiency may be improved.

Principles and implementations of the present disclosure will be described in detail below with reference to the figures.

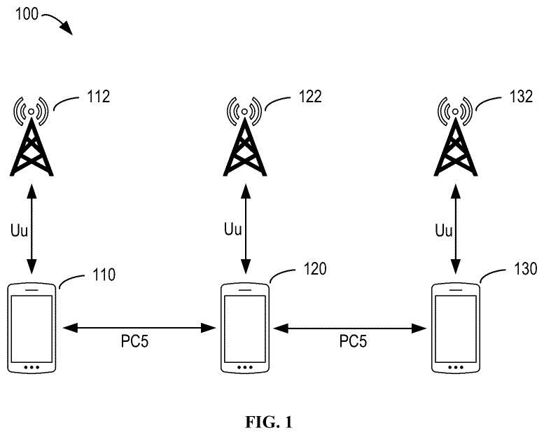

FIG. 1 illustrates a schematic diagram of an example communication network 100 in which some embodiments of the present disclosure can be implemented. As shown in FIG. 1, the communication network 100 may include a first terminal device 110, a second terminal device 120 and a third terminal device 130. In the example of FIG. 1, the first terminal device 110 may be connected with the second terminal device 120 via a sidelink interface (for example, PC5 as shown in FIG. 1), and also the third terminal device 130 may be connected with the second terminal device 120 via a sidelink interface (such as PC5). The first terminal device 110 may communicate with the third terminal device 130 via the second terminal device 120.

In some embodiments, the first terminal device 110 may transmit a message to the third terminal device 130 via the second terminal device 120. In this case, the first terminal device 110 serves as a source device, the second terminal device 120 serves as a relay device, and the third terminal device 130 serves as a destination device.

In some alternative embodiments, the third terminal device 130 may transmit a message to the first terminal device 110 via the second terminal device 120. In this case, the third terminal device 130 serves as a source device, the second terminal device 120 serves as a relay device, and the first terminal device 110 serves as a destination device. For convenience, the following description is given by taking a transmission from the first terminal device 110 to the third terminal device 130 via the second terminal device 120 as an example.

In some embodiments, the first terminal device 110 and the second terminal device 120 may communicate with each other via a sidelink channel, such as a physical sidelink shared channel (PSSCH), a physical sidelink control channel (PSCCH), a physical sidelink feedback channel (PSFCH), a physical sidelink broadcast channel (PSBCH) or the like. For example, a PC5 link or PC5 RRC connection may be established between the first terminal device 110 and the second terminal device 120. The third terminal device 130 and the second terminal device 120 may communicate with each other in a similar way as that for the first terminal device 110 and the second terminal device 120 and will not be repeated herein.

In some embodiments, the communication network 100 may include one or more network devices. As shown in FIG. 1, the communication network 100 may include network devices 112, 122 and 132. In some embodiments, the network device 112 may communicate with the first terminal device 110 via a Uu link, the network device 122 may communicate with the second terminal device 120 via a Uu link, and the network device 132 may communicate with the third terminal device 130 via a Uu link.

It is to be understood that the number of network devices in FIG. 1 is given for the purpose of illustration without suggesting any limitations to the present disclosure. In some embodiments, although the network devices for the first terminal device 110, the second terminal device 120 and the third terminal device 130 are shown separately, there may be only one serving network device, for example, the first terminal device 110, the second terminal device 120 and the third terminal device 130 may locate within the serving range of the one serving network device. The present disclosure does not limit this aspect.

The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

It is to be understood that the number of terminal devices in FIG. 1 is given for the purpose of illustration without suggesting any limitations to the present disclosure. In some embodiments, the communication network 100 may include any suitable number of second terminal devices, so that multiple hops are needed for the communication from the first terminal device 110 to the third terminal device 130. The present disclosure does not limit this aspect.

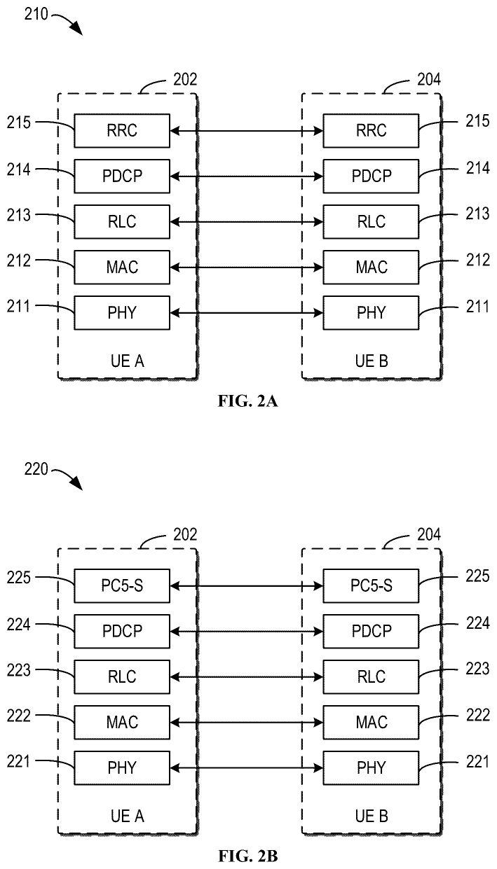

The communications between terminal devices in the communication network 100 may be performed in accordance with control plane protocol stacks. FIG. 2A illustrates a schematic diagram 210 of a control plane protocol stack for a SCCH for RRC in which some embodiments of the present disclosure can be implemented. FIG. 2B illustrates a schematic diagram 220 illustrating a control plane protocol stack for SCCH for PC5-S in which some embodiments of the present disclosure can be implemented. For illustration, the description in FIGS. 2A-2B is given by taking UE A 202 and UE B 204 as examples of the terminal devices. It is to be understood that UE A 202 may be the first terminal device 110 and UE B 204 may be the second terminal device 120 in FIG. 1, or UE A 202 may be the second terminal device 120 and UE B 204 may be the third terminal device 130 in FIG. 1. It is to be understood that UE A 202 and UE B 204 in FIGS. 2A-2B are given for the purpose of illustration without suggesting any limitations to the present disclosure.

As shown in FIG. 2A, in the control plane, each of the UE A 202 and UE B 204 may comprise a PHY layer 211, a MAC layer 212, an RLC layer 213, a PDCP layer 214 and an RRC layer 215. In some embodiments, the PHY layer 211 may also be referred to as a PHY entity, the MAC layer 212 may also be referred to as a MAC entity, the RLC layer 213 may also be referred to as an RLC entity, the PDCP layer 214 may also be referred to as a PDCP entity, and the RRC layer 215 may also be referred to as an RRC entity.

A sublayer (also referred to as a PC5-RRC layer) of the RRC layer 215 may provide the following services and functions over a PC5 interface: transfer of a PC5-RRC message between peer UEs; maintenance and release of a PC5-RRC connection between two UEs; and detection of sidelink radio link failure (RLF) for a PC5-RRC connection. A PC5-RRC connection is a logical connection between two UEs for a pair of Source and Destination Layer-2 IDs which is considered to be established after a corresponding PC5 unicast link is established. In some examples, there is one-to-one correspondence between the PC5-RRC connection and the PC5 unicast link.

As shown in FIG. 2B, in the control plane, each of the UE A 202 and UE B 204 may comprise a PHY layer 221, a MAC layer 222, an RLC layer 223, a PDCP layer 224 and a PC5-S layer 225. In some embodiments, the PHY layer 221 may also be referred to as a PHY entity, the MAC layer 222 may also be referred to as a MAC entity, the RLC layer 223 may also be referred to as an RLC entity, the PDCP layer 224 may also be referred to as a PDCP entity, and the PC5-S layer 225 may also be referred to as a PC5-S entity.

Generally, channels between the PC5-RRC layer and PDCP layer are called as sidelink radio bearers. A terminal device may be configured with at least one sidelink signalling radio bearer (SRB) for bearing control plane data. For each PC5-RRC connection of unicast, one sidelink SRB (i.e. SL-SRB0) is used to transmit the PC5-S message(s) before the PC5-S security has been established. One sidelink SRB (i.e. SL-SRB1) is used to transmit the PC5-S messages to establish the PC5-S security. One sidelink SRB (i.e. SL-SRB2) is used to transmit the PC5-S messages after the PC5-S security has been established, which is protected. One sidelink SRB (i.e. SL-SRB3) is used to transmit the PC5-RRC signalling, which is protected and only sent after the PC5-S security has been established.

The UE (may be referred to as TX UE) may initiate the sidelink RRC reconfiguration procedure and perform the operation on the corresponding PC5-RRC connection in following cases: (1) the release of sidelink data radio bearers (DRBs) associated with the peer UE; (2) the establishment of sidelink DRBs associated with the peer UE; (3) the modification for the parameters included in SLRB-Config of sidelink DRBs associated with the peer UE; (4) the (re-) configuration of the peer UE to perform NR sidelink measurement and report; (5) the (re-) configuration of the sidelink CSI reference signal resources and CSI reporting latency bound.

The TX UE may transmit an RRCReconfigurationSidelink message to the RX UE, and the configuration is completed in case an RRCReconfigurationCompleteSidelink message is received by the TX UE.

In some cases, the sidelink RRC reconfiguration procedure may be failed. In some embodiments, the TX UE may determine it fails in accordance with an expiry of a timer, T400 for example. TX UE may handle this case as a sidelink radio link failure (RLF):
consider sidelink radio link failure to be detected for this destination;
release the DRBs of this destination;
release the SRBs of this destination;
discard the NR sidelink communication related configuration of this destination;
reset the sidelink specific MAC of this destination;
consider the PC5-RRC connection is released for the destination; or
indicate the release of the PC5-RRC connection to the upper layers for this destination (i.e., PC5 is unavailable).

In some embodiments, if the RX UE is unable to comply with (part of) the configuration included in the RRCReconfigurationSidelink (i.e. sidelink RRC reconfiguration failure), the RX UE may send an RRCReconfigurationFailureSidelink message to the TX UE, and the RX UE may continue using the configuration used prior to the reception of the RRCReconfigurationSidelink message. Upon receiving the RRCReconfigurationFailureSidelink message, the TX UE may stop the timer (T400) for the RX UE and may continue using the configuration used prior to corresponding RRCReconfigurationSidelink message. In some embodiments, if the TX UE is in an RRC_CONNECTED state, the TX UE may transmit sidelink UE information (SUI) to its serving network device, such as a gNB.

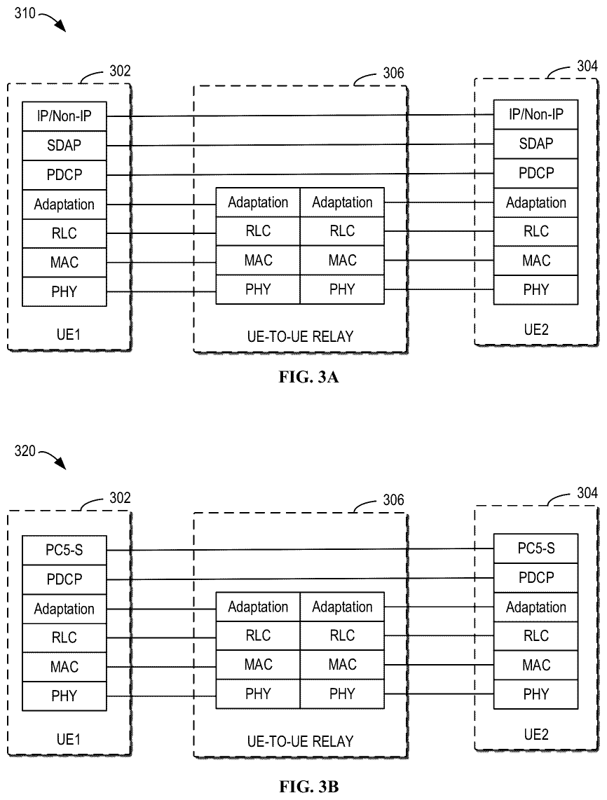

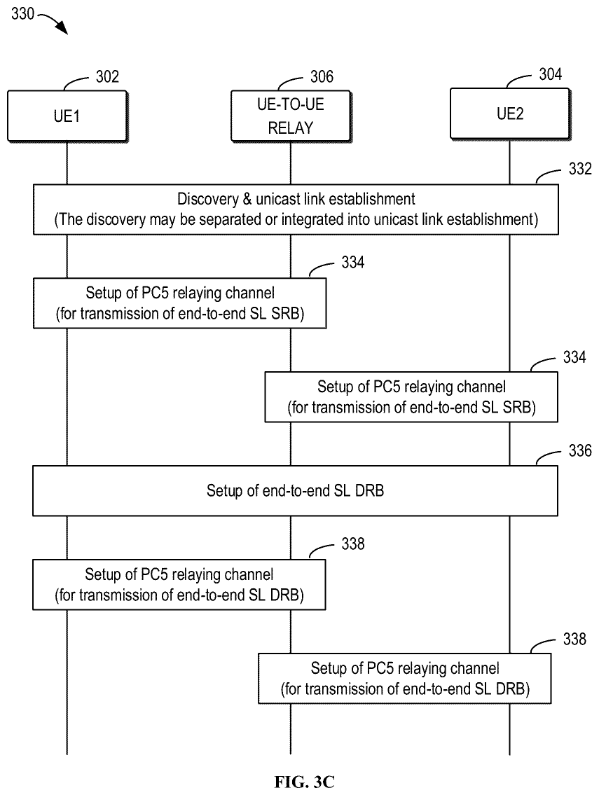

FIG. 3A illustrates a schematic diagram 310 of an E2E user plane protocol stack in which some embodiments of the present disclosure can be implemented. FIG. 3B illustrates a schematic diagram 320 of an E2E control plane protocol stack in which some embodiments of the present disclosure can be implemented. For illustration, the description in FIGS. 3A-3B is given by taking UE1 302, UE2 304 and a UE-to-UE relay 306 as examples of the terminal devices. It is to be understood that UE1 302 may be the first terminal device 110, UE2 304 may be the third terminal device 130, and the UE-to-UE relay 306 may be the second terminal device 120 in FIG. 1. It is to be understood that UEs 302, 304 and 306 in FIGS. 3A-3B are given for the purpose of illustration without suggesting any limitations to the present disclosure.

As shown in FIG. 3A, in E2E user plane, UE1 302 and UE2 304 may directly communicate with each other over PDCP layer, SDAP layer and IP/Non-IP layer. UE1 302 and UE2 304 may communicate with each other via a UE-to-UE Relay 306 over adaptation layer, RLC layer, MAC layer and PHY layer.

As shown in FIG. 3B, in E2E control plane, UE1 302 and UE2 304 may directly communicate with each other over PDCP layer and PC5-S layer. UE1 302 and UE2 304 may communicate with each other via a UE-to-UE Relay 306 over adaptation layer, RLC layer, MAC layer and PHY layer. The control plane protocol stack of a PC5 unicast link between UE1 302 and UE-to-UE Relay 306 or between UE2 304 and UE-to-UE Relay 306 may re-use the PC5-S protocol stack as shown in FIG. 2B.

FIG. 3C illustrates a schematic diagram 330 illustrating a general control plane procedure for U2U relay which can be used in some embodiments of the present disclosure.

At step 332, a UE-to-UE Relay discovery and a unicast link establishment is performed. The discovery procedure can be separated from or integrated into unicast link establishment procedure, which depends on SA2 decision. After the completion of discovery and unicast link establishment procedure, an end-to-end secured “extended” unicast link is established between UE1 302 and UE2 304, via the UE-to-UE Relay 306, i.e. a security association has been created between UE1 302 and UE2 304. In addition, the per hop PC5 RRC (between UE1 302 and UE-to-UE Relay 306, and between UE-to-UE Relay 306 and UE2 304) and the E2E PC5 RRC (between UE1 302 and UE2 304) are considered to be established/available.

At step 334, setup of PC5 relaying channel for transmission of end-to-end SL SRB(s) in each PC5 hop is performed. Per hop PC5 RRC is used for establishing the PC5 relaying channels, or specified configuration of PC5 relaying channels can be used.

At step 336, setup of end-to-end SL DRBs is performed. End-to-end PC5 RRC is used for establishing the end-to-end SL DRBs for end-to-end data transmission. The end-to-end PC5 RRC messages are mapped to the PC5 relaying channels established in step 334 to transmit.

At step 338, setup of PC5 relaying channels for transmission of end-to-end SL DRBs in each PC5 hop is performed. Per hop PC5 RRC is used for establishing the PC5 relaying channels. There is no strict time sequence of step 336 and step 338.

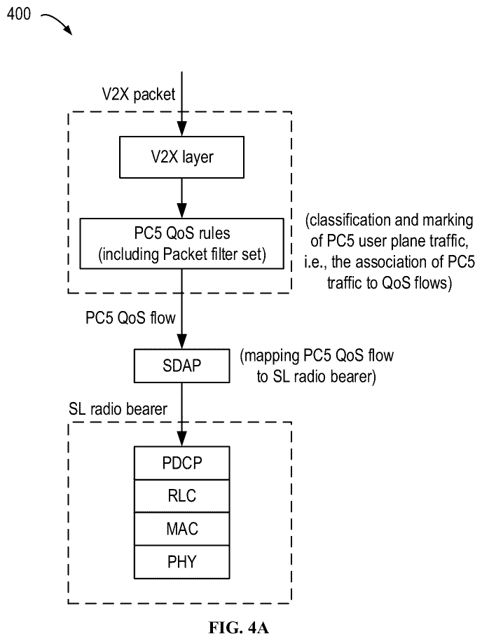

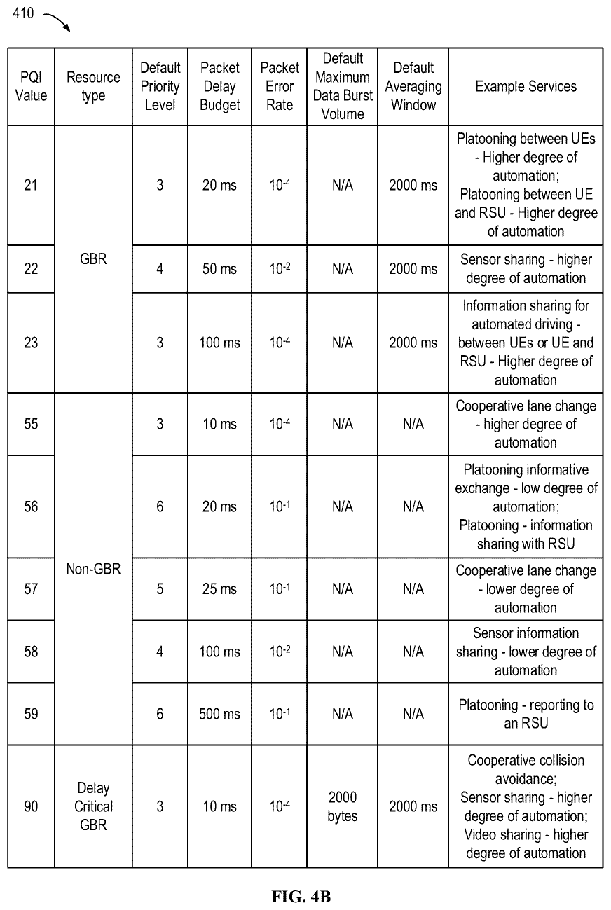

FIG. 4A illustrates a schematic diagram 400 illustrating PC5 quality of service (QoS) flow for vehicle to everything (V2X) in which some embodiments of the present disclosure can be implemented. It is to be understood that V2X may be regarded as a specific case of U2U transmission and the description in FIG. 4A is given for the purpose of illustration without suggesting any limitations.

For each communication mode (e.g., broadcast, groupcast, or unicast), the UE maintains the PC5 QoS Context and PC5 QoS Rule(s) for each PC5 QoS Flow identified by a PC5 QoS Flow Identifier (PFI) per destination identified by Destination Layer-2 ID. The PFI is unique within a same destination.

The V2X layer provides information for PC5 QoS operations per destination (e.g., identified by Destination Layer-2 ID) to access stratum (AS) layer for Per-flow QoS model operations as below: (1). To add a new PC5 QoS Flow or to modify any existing PC5 QoS Flow, the V2X layer provides the following information for the PC5 QoS Flow to AS layer: the PFI; the corresponding PC5 QoS parameters; and source/destination Layer-2 IDs for broadcast and groupcast mode communication, or the PC5 Link Identifier for unicast. (2). To remove any existing PC5 QoS Flow, the V2X layer provides the following information for the PC5 QoS Flow to AS layer: the PFI; and source/destination Layer-2 IDs for broadcast and groupcast mode communication, or the PC5 Link Identifier for unicast.

The above mentioned corresponding PC5 QoS parameters may include at least one of the following:
PC5 5QI (PQI);
PC5 Flow Bit Rates: (1) for GBR QOS Flows only, the following additional PC5 QoS parameters exist: Guaranteed Flow Bit Rate (GFBR) and/or Maximum Flow Bit Rate (MFBR). (2) for PC5 communication, the same GFBR and MFBR are used for both directions.
PC5 Link Aggregated Bit Rates: A PC5 unicast link is associated with the following aggregate rate limit QoS parameter: per link Aggregate Maximum Bit Rate (PC5 LINK-AMBR).
Range: the Range value indicates the applicability of the PC5 QoS parameters in PC5 communication, i.e. when the receiving UEs are not within the Range specified distance from the transmitting UE, the communication is best effort. And Range is only used for groupcast mode communication over PC5 reference point.

In some examples, PC5 QOS characteristics associated with PQI may be specified and the PC5 QoS characteristics may include at least one of: resource type, priority level, packet delay budget (PDB), packet error rate, averaging window, and maximum data burst volume. The resource type may be GBR, delay critical GBR or Non-GBR. The averaging window is included only for GBR and delay critical GBR resource type. The maximum data burst volume is included only for delay critical GBR resource type.

The association between the PQI value and the PC5 QOS characteristics may be standardized or may be pre-configured. Regarding standardized PC5 QoS characteristics, FIG. 4B illustrates an example one-to-one mapping 410 of PQI values to PC5 QoS characteristics. It is to be understood that the association shown in FIG. 4B is given for the purpose of illustration without suggesting any limitations to the present disclosure.

It is to be understood that the standardized PC5 QOS characteristics are not necessary, or the standardized PC5 QoS characteristics may be overridden in in some cases. The V2X layer may derive non-standardized PC5 QoS characteristics by overriding the standardized or pre-configured value of PC5 QoS characteristics based on V2X Application Requirements from V2X application layer, and may provide the whole set of non-standardized PC5 QoS characteristics to AS layer. A PQI may be used together with an application indicated priority, which overrides the Default Priority Level of the PQI.

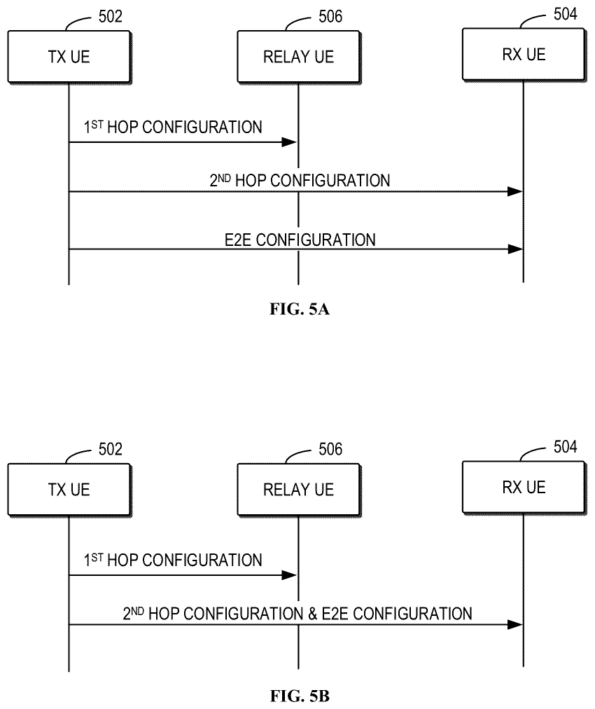

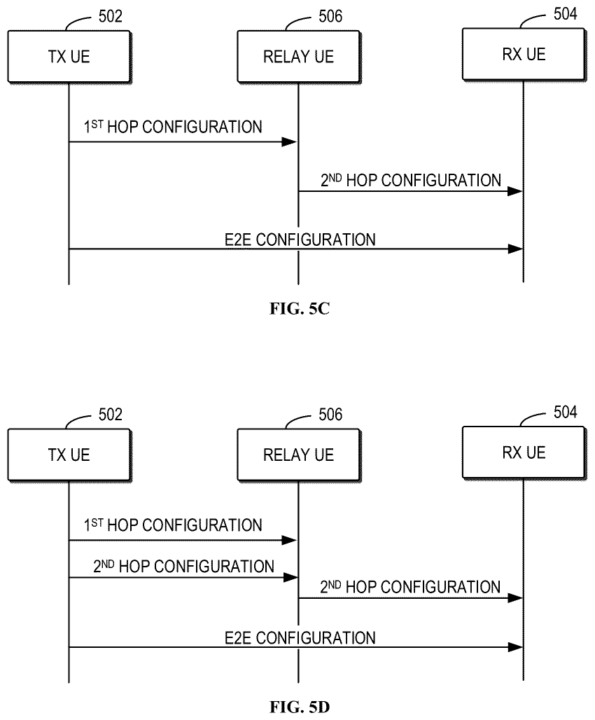

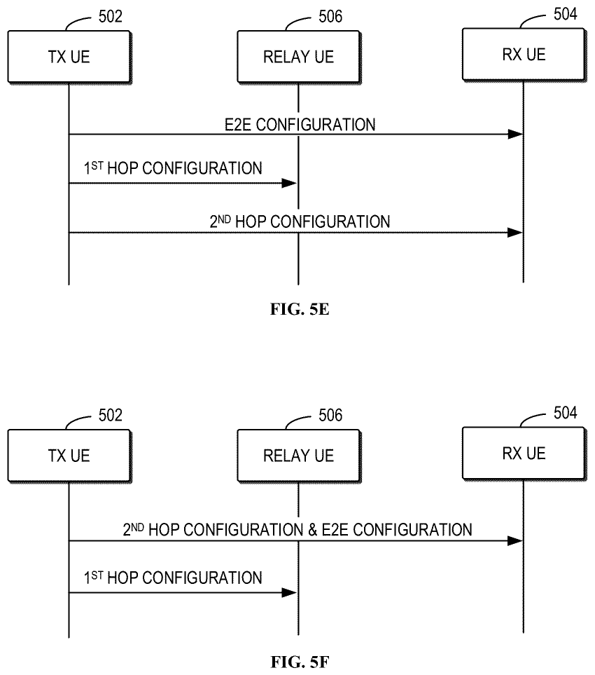

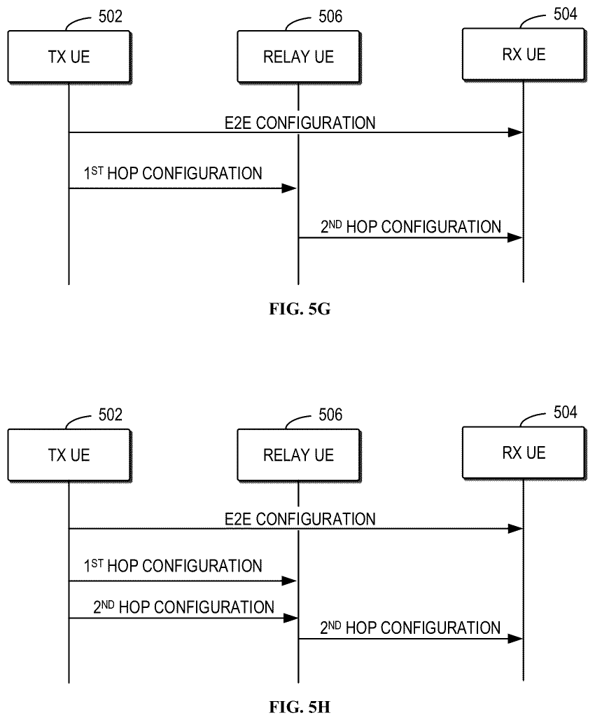

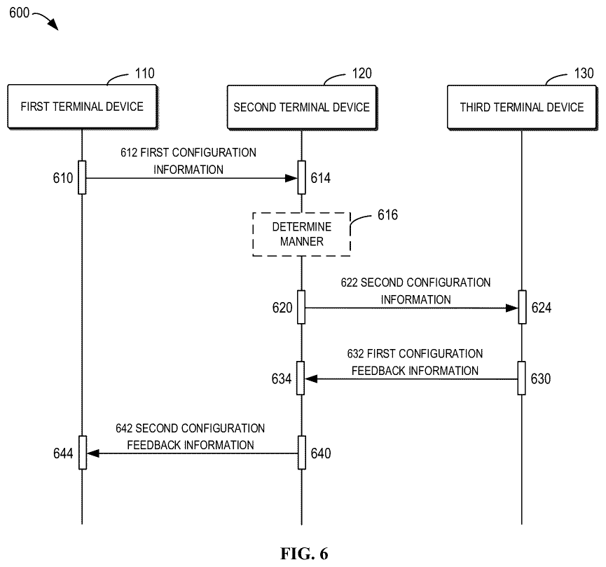

FIGS. 5A-5H illustrate some examples of configuring scenarios in which some embodiments of the present disclosure can be implemented. The processes in FIGS. 5A-5H may involve a TX UE 502, a RX UE 504 and a relay UE 506. The E2E PC5-S message may comprise E2E configuration, the per-hop PC5-S message may comprise a first hop configuration for the TX UE 502 and the relay UE 506 and a second hop configuration for the relay UE 506 and the RX UE 504. In some embodiments, the E2E configuration may be called as configuration of E2E SLRB (for example, it consists of at least the configuration of SDAP or PDCP for this E2E SLRB) and this disclosure does not limit this aspect. Alternatively or additionally, the E2E configuration further indicates a bearer mapping configuration between the SL DRB and the RLC channel for the first hop. Alternatively or additionally, the E2E configuration further indicates a bearer mapping configuration between the SL DRB and the RLC channel for the second hop.

As shown in FIGS. 5A-5D, the per-hop configuration may be performed first and then the E2E configuration may be performed. In some examples, as shown in FIG. 5A, the TX UE 502 transmits the first hop configuration to the relay UE 506, the TX UE 502 transmits the second hop configuration to the RX UE 504, and then the TX UE 502 transmits the E2E configuration to the RX UE 504. In this event, the TX UE 502 configures both the first hop and the second hop, and the TX UE 502 sends messages to the relay UE 506 and the RX UE 504 separately. In some examples, as shown in FIG. 5B, the TX UE 502 transmits the first hop configuration to the relay UE 506, and then the TX UE 502 transmits the second hop configuration and the E2E configuration to the RX UE 504. In this case, the second hop configuration may be transmitted together with the E2E configuration. In some examples, as shown in FIG. 5C, the TX UE 502 transmits the first hop configuration to the relay UE 506, the relay UE 506 transmits the second hop configuration to the RX UE 504, and then the TX UE 502 transmits the E2E configuration to the RX UE 504. In this case, the TX UE 502 configures the first hop and the relay UE 506 configures the second hop. In some examples, as shown in FIG. 5D, the TX UE 502 transmits the first hop configuration and the second hop configuration to the relay UE 506, the relay UE 506 forwards the second hop configuration to the RX UE 504, and then the TX UE 502 transmits the E2E configuration to the RX UE 504. The first hop configuration and the second hop configuration may be transmitted in a same message or in separate messages. In this case, the TX UE 502 configures both the first hop and the second hop where the second hop is configured by forwarding performed by the relay UE 506.

For the cases shown above, specifically in FIGS. 5C-5D, some problems are raised. For example, in case the configurations are successful, how the TX UE 502 can be aware of that the configuration of each hop has been successfully completed, especially for the second hop, and how to trigger the TX UE 502 to transmit the E2E configuration. For example, in case some of the configurations are failed, how the TX UE 502 can be aware of that the configuration of any hop failed, and how the TX UE 502 and the RX UE 504 to handle the failure case, especially for the second hop.

As shown in FIGS. 5E-5H, the E2E configuration may be performed first and then the per-hop configuration may be performed. In some examples, as shown in FIG. 5E, the TX UE 502 transmits the E2E configuration to the RX UE 504, the TX UE 502 transmits the first hop configuration to the relay UE 506, and then the TX UE 502 transmits the second hop configuration to the RX UE 504. In this case, the TX UE 502 configures both the first hop and the second hop, and the TX UE 502 sends messages to the relay UE 506 and the RX UE 504 separately. In some examples, as shown in FIG. 5F, the TX UE 502 transmits the second hop configuration and the E2E configuration to the RX UE 504, and then the TX UE 502 transmits the first hop configuration to the relay UE 506. In this case, the second hop configuration may be transmitted together with the E2E configuration. In some examples, as shown in FIG. 5G, the TX UE 502 transmits the E2E configuration to the RX UE 504, the TX UE 502 transmits the first hop configuration to the relay UE 506, and the relay UE 506 transmits the second hop configuration to the RX UE 504. In this case, the TX UE 502 configures the first hop and the relay UE 506 configures the second hop. In some examples, as shown in FIG. 5H, the TX UE 502 transmits the E2E configuration to the RX UE 504, the TX UE 502 transmits the first hop configuration and the second hop configuration to the relay UE 506, and the relay UE 506 forwards the second hop configuration to the RX UE 504. In this case, the TX UE 502 configures both the first hop and the second hop where the second hop is configured by forwarding performed by the relay UE 506.

For the cases shown above, some problems are raised. For example, in case some of the configurations are failed, specifically in FIG. 5F, how the TX UE 502 to be aware of that the configuration of the second hop is failed or the configuration of E2E SLRB is failed. For example, in case the configurations are successful, specifically in FIGS. 5G-5H, how the TX UE 502 to be aware of that the configuration of each hop has been successfully so as to trigger data transmission. For example, in case some of the configurations are failed, specifically in FIGS. 5G-5H, how the TX UE 502 to be aware of that the configuration of any one of those two hops is failed, and how to handle the failure case.

For example, referring to FIG. 5A-5B, 5D-5F or 5H, how the TX UE 502 to generate appropriate configuration for the second hop. For example, referring to FIG. 5C or 5G, how the relay UE 506 to determine the second hop configuration.

It should be understood that the above illustrated issues are only for the purpose of illustration without suggesting any limitations.

Embodiments of the present disclosure where the TX UE can be aware of the configuration status, i.e., successful or failed. Reference is first made to FIG. 6, which illustrates a signalling chart illustrating configuring process 600 according to some example embodiments of the present disclosure. Only for the purpose of discussion, the process 600 will be described with reference to FIG. 1. The process 600 may involve the first terminal device 110, the second terminal device 120 and the third terminal device 130 in FIG. 1. The second terminal device 120 may receive first configuration information from the first terminal device 110, and the second terminal device 120 may transmit configuration feedback information to the first terminal device 110. As such, the first terminal device 110 may be aware of at least whether the first reconfiguration is successful in time.

It is to be understood that the first terminal device 110 may be a TX UE, the second terminal device 120 may be a relay UE and the third terminal device 130 may be a RX UE.

The first terminal device 110 transmits 610 first configuration information 612 to the second terminal device 120. The first configuration information 612 indicates a first reconfiguration for a first channel between the second terminal device 120 and the third terminal device 130 and/or at least one QoS parameter for the first channel.

In some embodiments, the first configuration information 612 further indicates a second reconfiguration for a second channel between the first terminal device 110 and the second terminal device 120.

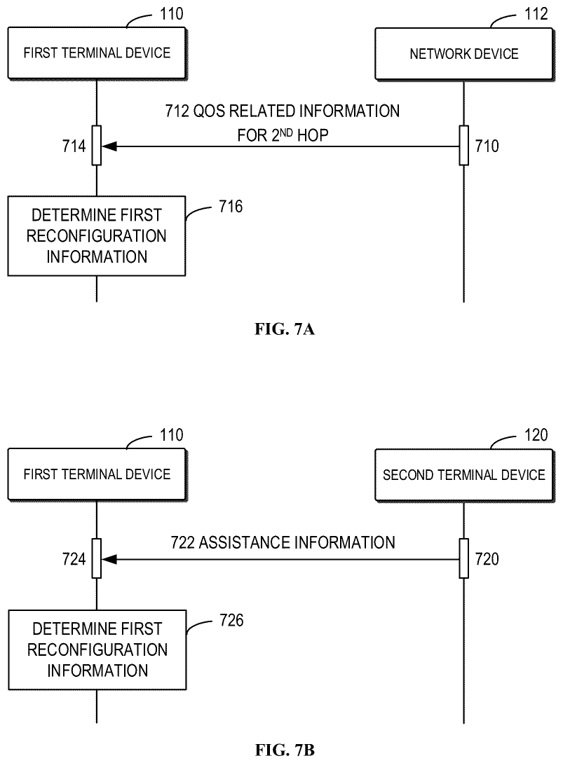

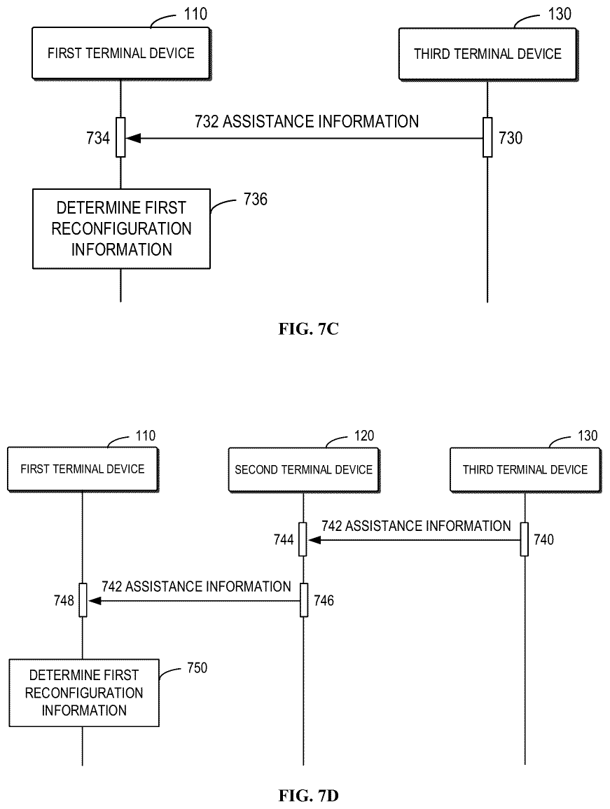

In some example embodiments, the first channel may comprise at least one RLC channel between the second terminal device 120 and the third terminal device 130 (also referred to as the RLC channel(s) for the second hop), the second channel may comprise at least one RLC channel(s) between the first terminal device 110 and the second terminal device 120 (also referred to as the RLC channel(s) for the first hop). In some examples, the RLC channel is also called as a RLC bearer and the present disclosure does not limit this aspect. For a communication from the first terminal device 110 to the third terminal device 130 via the second terminal device 120, the second reconfiguration may be regarded as reconfiguration (or configuration) of RLC channel for the first hop, and the first reconfiguration may be regarded as reconfiguration (or configuration) of RLC channel for the second hop. In some embodiments, the first reconfiguration and the second reconfiguration can be called as per-hop RLC channel configuration, per-hop PC5-S configuration, per-hop configuration for RLC channel, or per hop reconfiguration. For example, the second reconfiguration may be called as reconfiguration for the first hop, configuration for the first hop, or the first hop configuration. For example, the first reconfiguration may be called as reconfiguration for the second hop, configuration for the second hop, or the second hop configuration. The present disclosure does not limit this aspect. In some examples, one SL DRB (also referred to as End-to-End SL DRB) may be mapped to the RLC channel for the first hop and the RLC channel for the second hop for the data transmission between the first terminal device 110 and the third terminal device 130. Alternatively or additionally, the first configuration information 612 further indicates a bearer mapping configuration between the SL DRB and the RLC channel for the first hop. Alternatively or additionally, the first configuration information 612 further indicates a bearer mapping configuration between the SL DRB and the RLC channel for the second hop. In some embodiments, the first configuration information 612 indicates a first reconfiguration for the first channel between the second terminal device 120 and the third terminal device 130; that is, the first configuration information 612 indicates the second hop configuration. Alternatively or additionally, the first terminal device 110 may determine (or generate) information about the first reconfiguration (may be called as first reconfiguration information for the second hop). In some example embodiments, the first terminal device 110 may determine the first reconfiguration information for the second hop according to QoS related information for the first channel, in some examples, the QoS related information for the first channel may also be called as the QoS related information for the second hop. FIGS. 7A-7D illustrate signalling chart illustrating processes for determining the first reconfiguration information for the second hop by the first terminal device 110 in accordance with some embodiments of the present disclosure.

In some embodiments, as shown in FIG. 7A, the network device 112 transmits 710 the QoS related information for the second hop 712 to the first terminal device 110. Accordingly, the first terminal device 110 may receive 714 the QoS related information for the second hop 712. Then the first terminal device 110 determines 716 the first reconfiguration information for the second hop based on the QoS related information for the second hop 712. In some examples, the QOS related information for the second hop 712 may be transmitted through a Uu RRC signalling, for example, the QoS related information for the second hop 712 may be carried in UEAssistanceInformation (UAI). In this case, the network device 112 (gNB, for example) of the first terminal device 110 may configure the QOS related information for the second hop 712.

In some embodiments, as shown in FIG. 7B, the second terminal device 120 transmits 720 assistance information 722 to the first terminal device 110. Accordingly, the first terminal device 110 may receive 724 the assistance information 722. Then the first terminal device 110 determines 726 the first reconfiguration information for the second hop based on the assistance information 722. In some examples, the assistance information 722 may be carried in PC5-S signalling or PC5-RRC signalling. Alternatively, the assistance information 722 may be transmitted along with PC5-S signalling for connection establishment. For example, the second terminal device 120 may transmit the assistance information 722 in response to a connection establishment between the first terminal device 110 and the third terminal device 130 via the second terminal device 120 or a connection establishment between the first terminal device 110 and the second terminal device 120.

In some embodiments, as shown in FIG. 7C, the third terminal device 130 transmits 730 assistance information 732 to the first terminal device 110. Accordingly, the first terminal device 110 may receive 734 the assistance information 732. Then the first terminal device 110 determines 736 the first reconfiguration information for the second hop based on the assistance information 732. In some examples, the assistance information 732 may be carried in PC5-S signalling (for example, PC5-S signalling for connection establishment) or PC5-RRC signalling). For example, the third terminal device 130 may transmit the assistance information 732 in response to a connection establishment between the first terminal device 110 and the third terminal device130. Alternatively, the assistance information 732 is transmitted during or after configuring the E2E SL DRB. In some examples, the assistance information 732 may be transmitted through via SRB, e.g., a RRCReconfigurationSidelinkComplete message.

In some embodiments, as shown in FIG. 7D, the third terminal device 130 transmits 740 assistance information 742 to the second terminal device 120. The second terminal device 120 can receive 744 the assistance information 742 and forwards 746 the assistance information 742 to the first terminal device 110. Accordingly, the first terminal device 110 may receive 748 the assistance information 742. Then the first terminal device 110 determines 750 the first reconfiguration information for the second hop based on the assistance information 742. In some examples, the assistance information 742 may be carried in PC5-S signalling (for example, PC5-S signalling for connection establishment) or PC5-RRC signalling. For example, the third terminal device 130 may transmit the assistance information 742 in response to a connection establishment between the first terminal device 110 and the third terminal device130 or a connection establishment between the second terminal device 120 and the third terminal device 130. Alternatively, the assistance information 742 from the third device 130 may be transmitted during or after configuring the E2E SL DRB.

The assistance information 722/732/742 may indicate QoS assistance information for the second hop, for example, PDB, PER of specific PQI. The assistance information 722/732/742 may indicate traffic load information, for example, buffer status, the number of accessed RX UEs including the third terminal device 130, the number of established PC5 connections, data rate at different layers of the third terminal device 130, and/or the number of established RLC channels. The assistance information 722/732/742 may indicate an identifier (ID) of the third terminal device 130 or a pair of IDs of the second terminal device 120 and the third terminal device 130. The assistance information 722/732/742 may indicate relay load information, for example, buffering capacity available or buffer load for relayed date on the second terminal device 120, resource pool usage or capacity, data rate at different layers of the second terminal device 120 for relaying data and/or average time the relayed data stays at the second terminal device 120. It is to be understood that the assistance information 722/732/742 may indicate one or any combination of those stated above, and the present disclosure will not list redundantly.

It is noted that the assistance information 722 from the second terminal device 120 or the assistance information 732/742 from the third terminal device 130 can help the first terminal device 110 to make more appropriate configuration for the second hop, i.e., the first reconfiguration for the first channel (the second hop configuration). In this event, the possibility of successful reconfiguration for the second hop can be increased.

In some embodiments, the first configuration information 612 indicates at least one QoS parameter for the first channel between the second terminal device 120 and the third terminal device 130.

In some examples, the QoS related information for the second hop may be configured by the network device 112, for example referring to operation 710 in FIG. 7A. Alternatively or additionally, the first terminal device 110 may transmit at least one set of QoS parameters to the second terminal device 120. As such, the first terminal device 110 can provide QoS related information to the second terminal device 120. For ease of description, the message carrying the at least one set of QoS parameters may be called as a QoS message, which can be transmitted via broadcast, multicast, or unicast. For example, the broadcast QoS message may be PC5-S signalling, such as a discovery message. For example, the unicast QoS message may be PC5-S signalling or PC5-RRC signalling (such as RemoteUEInformationSidelink, RUIS). In some example embodiments, each of the at least one set of QoS parameters may comprise a whole set of non-standardized PC5 QoS characteristics. In some example embodiments, the at least one set of QoS parameters may comprise at least one pair of PQI and its corresponding application indicated priority. In some example embodiments, the at least one QoS parameter indicated by the first configuration information 612 may comprise a PQI value. Alternatively, the at least one QoS parameter may further indicate which set of QoS parameters (in the at least one set of QoS parameters) to be used, standardized or ono-standardized.

In some examples, the QOS related information for the second hop may be determined (or generated) based on assistance information from the second terminal device 120 or from the third terminal device 130. The assistance information may refer to those described above referring to FIGS. 7B-7D and will not repeated herein.

In some example embodiments, the at least one QoS parameter for the second hop may comprise at least one of: a PQI, a set of QoS parameters, or at least one pair of PQI and corresponding application indicated priority. The set of QoS parameters indicates a whole set of PC5 QoS characteristics including a PC5 flow bit rate, a resource type, a priority level, a packet delay budget, a packet error rate, a maximum data burst volume and an averaging window.

In some examples, the at least one QoS parameter comprises a PQI value. In this case, other PC5 QOS characteristics may be determined based on the PQI value. For example, a standardized or a pre-configured association may be used for determining other PC5 QOS characteristics. In some examples, the at least one QoS parameter for the second hop comprises a PQI value and an application indicated priority. For example, other PC5 QoS characteristics such as a PC5 flow bit rate, a resource type, a priority level, a packet delay budget, a packet error rate, a maximum data burst volume and an averaging window may be determined based on the PQI value and a standardized or a pre-configured association, then the priority level may be replaced by the application indicated priority. In some examples, the at least one QoS parameter for the second hop comprises a whole set of non-standardized PC5 QoS characteristics.

It is to be understood that the description of the at least one QoS parameter is given for the purpose of illustration without suggesting any limitations to the present disclosure. In some embodiments, the at least one QoS parameter may refer to one or more PC5 QoS parameters stated above referring to FIGS. 4A-4B.

In some example embodiments, the first terminal device 110 may transmit information about the second reconfiguration (may be called as second reconfiguration information for the first hop) and information about the first reconfiguration (may be called as first reconfiguration information for the second hop), without transmission of the at least one QoS parameter for the second hop. In some example embodiments, the first terminal device 110 may transmit the second reconfiguration information for the first hop and the at least one QoS parameter for the second hop, without transmission of the first reconfiguration information for the second hop. In some example embodiments, the first terminal device 110 may transmit all of the second reconfiguration information for the first hop, the first reconfiguration information for the second hop and the at least one QoS parameter for the second hop.

It is to be understood that, the first configuration information 612 may be transmitted through any message or signalling from the first terminal device 110 to the second terminal device 120. In some embodiments, the first configuration information 612 may be transmitted through at least one of: PC5-S signalling, PC5-RRC signalling, a discovery message, a MAC CE, or an SCI. In some embodiments, the first configuration information 612 may be transmitted through separated messages, for example, the first configuration information 612 indicates the first reconfiguration and the second reconfiguration which are carried in different messages.

In some example embodiments, the message carrying the first configuration information may be called a first configuration message, it is understood that the first configuration message includes second reconfiguration information for the first hop, first reconfiguration information and/or at least one QoS parameter for the second hop. In some embodiments, the first configuration message may be transmitted through at least one of: a PC5-S signalling, a PC5-RRC signalling, a MAC CE, or an SCI. Alternatively, the first configuration message may be implemented as an RRCReconfigurationSidelink message.

It is assumed that the first configuration information 612 is carried in the first configuration message. In some embodiments, the first configuration message may comprise some other indication(s) and/or information.

In some example embodiments, the first configuration message may comprise an identifier of the third terminal device 130 or an identifier of a link between the second terminal device 120 and the third terminal device 130. For example, the first configuration message may comprise a UE ID indicating the third terminal device 130. For example, the first configuration message may comprise a link ID indicating the sidelink between the second terminal device 120 and the third terminal device 130.

In some example embodiments, the first configuration message may comprise multiple reconfigurations of the first channel for the second hop. For example, each of the multiple reconfigurations is corresponding to different QoS requirements. Alternatively, each of the multiple reconfigurations is corresponding to the same QoS requirement.

In some example embodiments, the first configuration message may comprise an indication of a maximum number. In some examples, the maximum number may be configured by the network device 112 or may be determined by the first terminal device 110. In some embodiments, the maximum number may represent a maximum number for configuring the second hop (including the reconfiguration for the very first time) or represent a maximum number for retrying configuration of the second hop (excluding the reconfiguration for the very first time). In other words, the maximum number may indicate a maximum number of retries being performed for retrying reconfiguration of the first channel (second hop), directly or implicitly. It is assumed that the maximum number of retries may be represented as an integer N.

In some example embodiments, the first configuration message may comprise an indication of whether the second terminal device 120 is allowed to retry the first reconfiguration.

In some example embodiments, the first configuration message may comprise a set of retry reconfiguration information for the first channel. In some examples, there are N pieces of retry reconfiguration information, which indicates the maximum number (N) of retries implicitly.

In some example embodiments, the first terminal device 110 may start a timer (a second timer for reference) while transmitting the first configuration information 612. In other words, the second timer may be started in response to the transmission of the first configuration information 612. The time length of the second timer may be pre-determined, pre-defined or pre-configured. In some examples, the second timer can be a known timer, T400 for example. In some examples, the second timer may be a newly-defined timer, which may be called as a T400-like timer.

In some example embodiments, the first terminal device 110 may choose a second timer and start the chosen second timer. In some examples, there may be a list of timers at the first terminal device 110 and the first terminal device 110 may determine which timer to be used. It is to be understood that different times have different time lengths. In some examples, a time length of a timer may be called as a value of the timer. In some embodiments, the list of timers may include a T400 timer and a T400-like timer. Alternatively, the first terminal device 110 may choose the second timer according to traffic type. For example, if the configuration is for relay traffic, the T400-like timer may be chosen. For example, if the configuration is for non-relay traffic, the T400 timer may be chosen.

For ease of description, the time length of the second timer, the second time length for short, may be represented as T2.

Alternatively or additionally, the first terminal device 110 may further transmit an indication comprising at least one of: a first time length, multiple time lengths comprising the first time length, a second time length of a second timer, a third time length as the upper bounder/threshold of the first time length, or a set of time lengths corresponding to a set of terminal devices comprising the first terminal device 110 or the third terminal device130. In some embodiments, the indication is comprised in the first configuration information 612 or transmitted separately from the first configuration information 612. In some embodiments, the indication may be transmitted through a PC5-RRC message (such as RUIS), a MAC CE or an SCI.

In some example embodiments, the first terminal device 110 may transmit an indication of the second time length to the second terminal device 120.

In some example embodiments, the first terminal device 110 may transmit an indication of a first time length to the second terminal device 120. For example, the first terminal device 110 may decide how long the configuring process for the second hop is needed, and further determine the first time length based thereon.

In some example embodiments, the first terminal device 110 may transmit an indication of multiple time lengths to the second terminal device 120. The multiple time lengths may be called as multiple candidates for the first time length. In this event, the second device 120 may choose one as the first time length from the multiple time lengths.

In some example embodiments, the first terminal device 110 may transmit an indication of multiple time lengths corresponding to multiple RX UEs, where the multiple RX UEs includes the third terminal device 130. In this event, the second device 120 may determine the first time length from the multiple time lengths, based on an identifier of the third terminal device 130.

In some example embodiments, the first terminal device 110 may transmit an indication of at least two time lengths to the second terminal device 120, where the at least two time lengths includes a time length for relay traffic and another time length for non-relay traffic. In this case, the indication can differentiate the configuration of non-relay traffic from that of relay traffic, e.g., configuration with RX UE ID. Alternatively, the time length for relay traffic and/or for non-relay traffic may be pre-configured by the network device 112.

In some embodiments, as described above, the first configuration information 612 may be carried in the first configuration message; alternatively, the first configuration message may comprise an indication of the first time length and/or the second time length, explicitly or implicitly. In some examples, the first time length is shorter than the second time length. If the first time length is represented as T1 and the second time length is represented as T2, T1<T2 should be met. In some other example, there is no limitation on the relation of T1 and T2, T1 may be greater or shorter than T2, or T1 may be equal to T2. The present disclosure does not limit this aspect.

Now further referring to FIG. 6, on the other side of communication, the second terminal device 120 receives 614 the first configuration information 612.

In case the first configuration information 612 indicates the first reconfiguration for the first channel between the second terminal device 120 and the third terminal device 130, the second terminal device 120 can obtain information about the first reconfiguration directly.

In case the first configuration information 612 indicates the at least one QoS parameter for the first channel between the second terminal device 120 and the third terminal device 130 but without the first reconfiguration, the second terminal device 120 can generate the first reconfiguration based on the at least one QoS parameter. In other words, if the first configuration information 612 does not indicate the first reconfiguration for the first channel between the second terminal device 120 and the third terminal device 130 directly but indicates at least one QoS parameter for the first channel, the second terminal device 120 may generate the first reconfiguration for the first channel based on the at least one QoS parameter.

In some embodiments, the first configuration information 612 may further indicate the second reconfiguration for the second channel between the first terminal device 110 and the second terminal device 120. In this case, the second terminal device 120 may determine whether the second reconfiguration is successful. Specifically, the second terminal device 120 may determine whether it can comply with the second reconfiguration. If the second terminal device 120 can comply with the second reconfiguration, it may determine that the configuration for the second channel is successful. If the second terminal device 120 is unable to comply with at least a part of the second reconfiguration, it may determine that the configuration for the second channel is failed. For example, if the second reconfiguration indicates RLC AM for one DRB, but the second terminal device 120 support RLC UM currently, then the second terminal device 120 may determine that it is unable to comply with (part of) the second reconfiguration. For example, if the second reconfiguration indicates RLC AM with 4 times of retransmissions for one DRB, but the second terminal device 120 support RLC AM with only 2 times of retransmissions, then the second terminal device 120 may determine that it is unable to comply with (part of) the second reconfiguration.

Now further referring to FIG. 6, the second terminal device 120 transmits 620 second configuration information 622 to the third terminal device 130. Specifically, the second terminal device 120 may determine the second configuration information 622 based on the first configuration information 612, and the second configuration information 622 indicates the first reconfiguration for the first channel between the second terminal device 120 and the third terminal device 130. Alternatively or additionally, the second configuration information 622 further indicates a bearer mapping configuration for the SL DRB and the RLC channel for the second hop.

In some example embodiments, if the first configuration information 612 indicates the first reconfiguration, the second terminal device 120 may forward the information about the first reconfiguration. In this case, the second configuration information 622 may be the first reconfiguration information for the second hop. In other words, the second terminal device 120 may forward the first reconfiguration information for the second hop if the first reconfiguration information for the second hop has been received by the second terminal device 120.

In some example embodiments, if the first configuration information 612 indicates the at least one QoS parameter (without the first reconfiguration), the second terminal device 120 may determine the first reconfiguration information for the second hop based on the at least one QoS parameter, and then the determined first reconfiguration information may be transmitted to the third terminal device 130. In other words, the second terminal device 120 may determine the first reconfiguration information for the second hop if the second terminal device 120 does not receive the first reconfiguration information but has received the at least one QoS parameter.

In some example embodiments, the at least one QoS parameter may comprise a whole set of PC5 QOS characteristics. In some example embodiments, an association of the at least one QoS parameter (such as a PQI value, or a PQI value and corresponding application indicates priority) with other PC5 QoS characteristics has been pre-configured by the network device 122 or has been indicated (for example, through a QoS message described above) by the first terminal device 110, standardized or non-standardized, then the second device 120 may determine the set of PC5 QOS characteristics based on the at least one QoS parameter and the association.

In some example embodiments, the second terminal device 120 may forward the at least one QoS parameter to the network device 122, and then the second terminal device 120 may receive the set of PC5 QOS characteristics from the network device 122. For example, if the at least one QoS parameter comprises a PQI value, the second terminal device 120 may request the set of PC5 QoS characteristics from an upper layer with the PQI value. In some examples, the at least one QoS parameter may be forwarded through a Uu RRC signalling, such as SidelinkUeInformation (SUI). In some examples, the set of PC5 QOS characteristics from the network device 122 is forwarded through a Uu RRC signalling, such as UAI.

In this event, the second terminal device 120 can determine the first reconfiguration information based on the at least one QoS parameter.

In some examples, the second configuration information 622 may further indicate the identifier of the third terminal device 130, which may be represented as an RX UE ID (e.g. Layer 2 ID), a pair of RX UE ID and TX UE ID or link ID corresponding to the RX UE or the pair of TX UE and RX UE.

Alternatively or additionally, in some example embodiments, if the first configuration information 612 indicates the at least one QoS parameter, the second terminal device 120 may forward the at least one QoS parameter to other relay UE(s), e.g., for the configuration of multiple hops. Alternatively, other relay UE may report the at least one QoS parameter to its serving network device if it connects to its serving network device.

Alternatively or additionally, in some example embodiments, the second terminal device 120 may determine 616 which transmitting manner to be used. The transmitting manner may be a forwarding manner or a determining manner (or a generating manner).

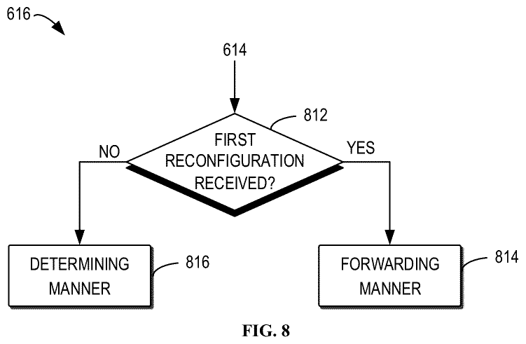

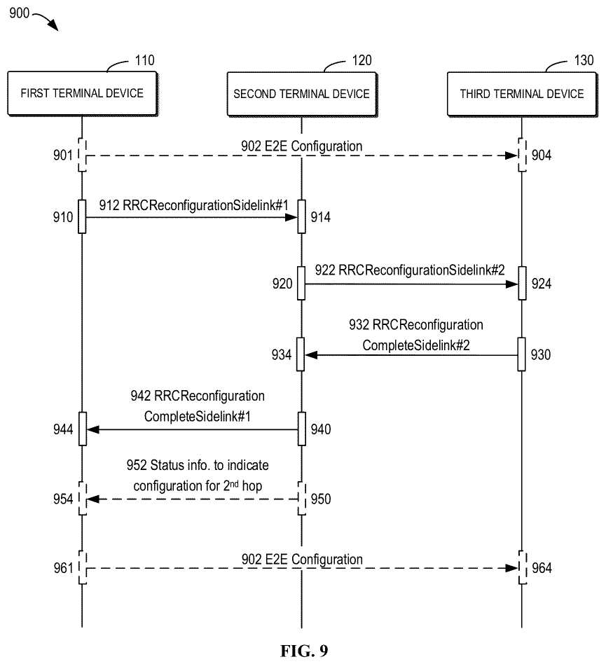

FIG. 8 illustrates an example process 616 for determining the transmitting manner according to some example embodiments of the present disclosure. At block 812, the second terminal device 120 may determine the first reconfiguration information has been received. If yes, the second terminal device 120 may determine the manner as forwarding manner at block 814. If no, the second terminal device 120 may determine the manner as determining (or generating) manner at block 816. In this case, if both manners are allowed or available for the second terminal device 120, the second terminal device 120 may decide which manner to be used based on received information.

In some other example embodiments, the second terminal device 120 may determine whether the received reconfiguration information for the second hop only indicates the at least one QoS parameter. If no, the second terminal device 120 may determine the manner as forwarding. If yes, the second terminal device 120 may determine the manner as determining (or generating). It is to be understood that this case is similar with that show in FIG. 8.

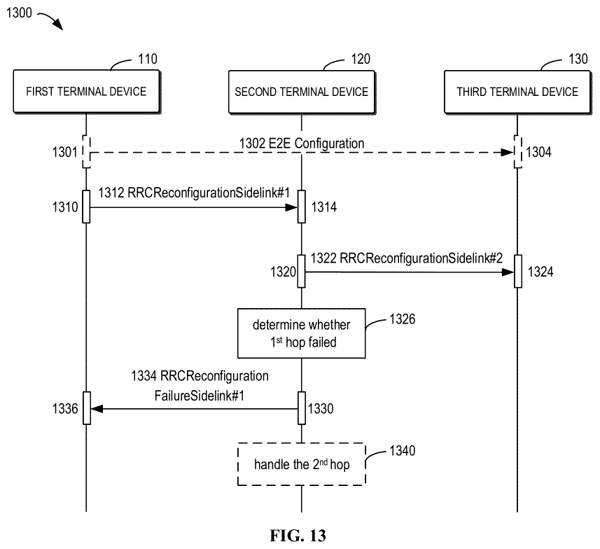

In some example embodiments, the second terminal device 120 may transmit the second configuration information 622 only if the second reconfiguration is successful (or completed). In other words, if the second terminal device 120 complies with the second reconfiguration for the first hop, it can transmit the second configuration information 622 to the third terminal device 130. If the second terminal device 120 is unable to comply with (part of) the second reconfiguration for the first hop, it may not transmit the second configuration information 622, some example embodiments related to the failed second reconfiguration will be further detailed hereinafter with reference to FIGS. 12-13.

In some example embodiments, the second terminal device 120 may transmit the second configuration information 622 upon reception of the first configuration information 612. In this case, the second configuration information 622 is transmitted regardless of the configuration status of the first hop.

In some example embodiments, the message carrying the second configuration information may be called a second configuration message, it is understood that the second configuration message includes first reconfiguration information for the second hop. In some embodiments, the second configuration message may be transmitted through at least one of: a PC5-S signalling, a PC5-RRC signalling, a discovery message, a MAC CE, or an SCI. Alternatively, the second configuration message may be implemented as an RRCReconfigurationSidelink message.

In some example embodiments, the second terminal device 120 may determine a first time length and start a first timer with the first time length while transmitting the second configuration information.

In some examples, an indication of the first time length (T1) is received from the first terminal device 110, and the second terminal device 120 can obtain the first time length directly.

In some examples, an indication of multiple time lengths (candidates) is received from the first terminal device 110, and the second terminal device 120 may choose/select one as the first time length, based on a specific implementation of the second terminal device 120 for example.

In some examples, an indication of the second time length is received from the first terminal device 110, and the second terminal device 120 may determine the first time length based on the second time length. For example, a value less than the second time length may be determined as the first time length, based on a specific implementation of the second terminal device 120 for example. Thus, in case the second time length (T2) is provides, the second terminal device 120 may determine the first time length (T1) which should be shorter than the second time length. However, in some other cases, a value greater than the second time length may be determined as the first time length and the present disclosure does not limit this aspect.

In some examples, an indication of multiple time lengths corresponding to multiple RX UEs is received from the first terminal device 110, and the second terminal device 120 may determine the first time length based on an identify of the third terminal device 130.

In some examples, an indication of at least two time lengths including a time length for relay traffic and another time length for non-relay traffic is received from the first terminal device 110, and the second terminal device 120 may determine the first time length based on the relay traffic from the first terminal device 110 to the third terminal device 130.

In some examples, multiple time lengths corresponding to multiple TX UEs have been indicated or pre-configured, by the network device 122 for example, and the second terminal device 120 may determine the first time length based on an identify of the first terminal device 110.

In some examples, multiple time lengths corresponding to multiple RX UEs have been indicated or pre-configured, by the network device 122 for example, and the second terminal device 120 may determine the first time length based on an identify of the third terminal device 130.

In some examples, multiple time lengths corresponding to multiple pairs of TX UE and RX UE have been indicated or pre-configured, by the network device 122 for example, and the second terminal device 120 may determine the first time length based on identifies of the first terminal device 110 and the third terminal device 130.

On the other side of communication, the third terminal device 130 receives 624 the second configuration information 622.

In some example embodiments, the third terminal device 130 may determine whether the first reconfiguration is successful. Specifically, the third terminal device 130 may determine whether it can comply with the first reconfiguration. If the third terminal device 130 can comply with the first reconfiguration, it may determine that the configuration for the first channel is successful. If the third terminal device 130 is unable to comply with at least a part of the first reconfiguration, it may determine that the configuration for the first channel is failed. For example, if the first reconfiguration indicates RLC AM for one DRB, but the third terminal device 130 support RLC UM currently, then the third terminal device 130 may determine that it is unable to comply with (part of) the first reconfiguration. For example, if the first reconfiguration indicates RLC AM with 4 times of retransmissions for one DRB, but the third terminal device 130 support RLC AM with only 2 times of retransmissions, then the third terminal device 130 may determine that it is unable to comply with (part of) the first reconfiguration.

The third terminal device 130 transmits 630 first configuration feedback information 632 to the second terminal device 120. The first configuration feedback information 632 may indicate whether the first reconfiguration is successful or failed.

In some example embodiments, the first configuration feedback information 632 may be carried in any message or signalling from the third terminal device 130 to the second terminal device 120. In some examples, the first configuration feedback information 632 may be transmitted through a PC5 RRC message, a MAC CE or an SCI. For example, it is carried in a RUIS message or a new PC5 RRC message, the present disclosure does not limit this aspect.

It is to be understood that the first configuration feedback information may indicate a successful reconfiguration of the second hop or a failed reconfiguration of the second hop, similar to ACK or NACK.

In some examples, the first configuration feedback information 632 may further indicate the identifier of the third terminal device 130, which may be represented as an RX UE ID.

On the other side of communication, the second terminal device 120 receives 634 the first configuration feedback information 632. In this event, the second terminal device 120 may be aware the configuration state of the second hop.

The second terminal device 120 transmits 640 second configuration feedback information 642 to the first terminal device 110.

In some example embodiments, the second configuration feedback information 642 may indicate whether the first reconfiguration is successful/failed and/or whether the second reconfiguration is successful/failed.

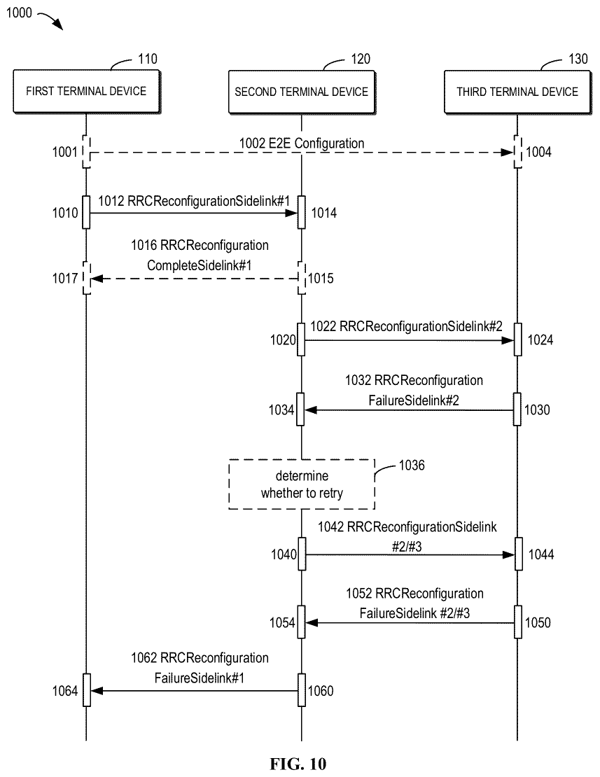

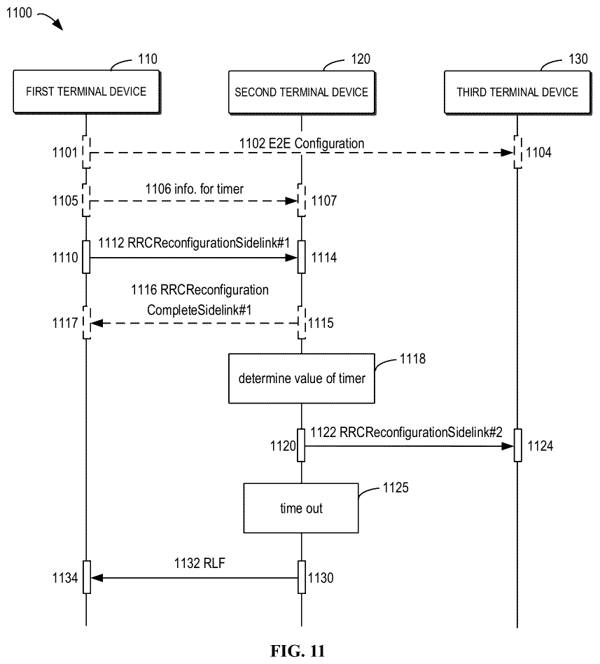

If the first configuration feedback information 632 indicates that the first reconfiguration is successful, the second terminal device 120 may be aware of the successful configuration of the second hop directly. On the other hand, the second terminal device 120 may determine that the first reconfiguration is failed if: (1) the first configuration feedback information 632 indicates that the first reconfiguration is failed, (2) the maximum number of retries is reached, the retries being performed for retrying reconfiguration of the first channel, (3) expiry of the first timer, or (4) the second reconfiguration is failed. Some example embodiments related to the failed first reconfiguration will be further detailed hereinafter with reference to FIGS. 10-13.

In case both the first reconfiguration and the second reconfiguration are successful, the second configuration feedback information 642 may be complete information or successful information.

In case one or two of the first reconfiguration and the second reconfiguration is failed, the second configuration feedback information 642 may be failure information with or without indicating which hop is failed. In some examples, the second configuration feedback information 642 indicates failed configuration, no matter which hop is failed. In some examples, the second configuration feedback information 642 indicates which hop is failed.

In some embodiments, the second configuration feedback information 642 may indicate at least one hop ID and corresponding reconfiguration state (successful or failed). For example, the second configuration feedback information 642 may indicate an ID of the first hop and its reconfiguration state (e.g. a failed reconfiguration or a successful reconfiguration), or may indicate an ID of the second hop and its reconfiguration state. For example, the second configuration feedback information 642 may indicate IDs of all hops (for a TX-RX UE pair or for a PC5 unicast link) and their reconfiguration states respectively.

In some examples, a bit map may be used for the second configuration feedback information 642. The length of the bits in the bit map may equal to the number of hops from the first terminal device 110 to the third terminal device 130, or may be a pre-configured value larger than the number of hops from the first terminal device 110 to the third terminal device 130. One bit in the bit map may correspond to a hop and indicate the reconfiguration state of the corresponding hop. For example, a bit is set to “1” to indicate a failed reconfiguration of the corresponding hop. Accordingly, “10” indicates the reconfiguration for the first hop is failed, “01” indicates the reconfiguration for the second hop is failed, “11” indicates the reconfigurations for both hops are failed, and “00” indicates the reconfigurations for both hops are successful.

In some examples, a pre-defined code may be used for the second configuration feedback information 642. For example, “00” indicates the reconfiguration for the first hop is failed, “01” indicates the reconfiguration for the second hop is failed, “10” indicates the reconfigurations for both hops are failed, and “11” indicates the reconfigurations for both hops are successful.

It is to be understood that the examples described above are only for the purpose of illustration without suggesting any limitations.

In some embodiments, the first configuration feedback information 632 may be transmitted in a RRC container via the second configuration feedback information 642. Alternatively or additionally, the second configuration feedback information 642 may indicate an ID of the first hop and its reconfiguration state.

In some examples, the second configuration feedback information 642 may further indicate the identifier of the third terminal device 130. The identifier of the third terminal device 130 may be represented as an RX UE ID (e.g. Layer 2 ID), a pair of RX UE ID and TX UE ID, or link ID corresponding to the RX UE or the pair of TX UE and RX UE.

On the other side of communication, the first terminal device 110 receives 644 the second configuration feedback information 642. In this event, the first terminal device 110 may be aware the configuration state of the first hop and/or the second hop.

According to the embodiments described with reference to FIG. 6, the first terminal device 110 may receive the configuration feedback information and be aware of whether the second hop is successfully configured, and thus a further consideration may be made by the first terminal device 110. For example, if the second hop is not successfully configured, the first terminal device 110 may perform a reconfiguration or may choose another relay UE, without waiting for the expiry of the second timer. In this regard, the processing efficiency may be improved.

In some embodiments, the first terminal device 110 may transmit third configuration information indicating E2E configuration for bearer between the first terminal device 110 and the third terminal device 130. In some examples, the first terminal device 110 may transmit the third configuration information to the third terminal device 130 prior to the transmission of the first configuration information 612. In some examples, the first terminal device 110 may transmit the third configuration information to the third terminal device 130 after receiving the configuration feedback information indicating both the first and the second reconfigurations are successful.

In some example embodiments, the E2E configuration for bearer between the first terminal device 110 and the third terminal device 130 may be regarded as E2E configuration for SL BRB, E2E PC5-S configuration, E2E SLRB configuration, or E2E configuration for short. The present disclosure does not limit this aspect.

It is assumed that the first and second configuration information is transmitted through an RRCReconfigurationSidelink message and the first and second configuration feedback information is transmitted through an RRCReconfigurationCompleteSidelink message or an RRCReconfigurationFailureSidelink message or RLF. Example embodiments related to these specific messages will be further detailed hereinafter with reference to FIGS. 9-13.

FIG. 9 illustrates a signalling chart illustrating configuring process 900 according to some example embodiments of the present disclosure.

The first terminal device 110 transmits 910 a first RRC reconfiguration Sidelink message (i.e. RRCReconfigurationSidelink #1 shown in FIG. 9) 912 to the second terminal device 120. The RRCReconfigurationSidelink #1 912 includes configuration information of RLC channel for the first hop, and includes configuration information of RLC channel for the second hop and/or QoS related information for the second hop.

The second terminal device 120 receives 914 RRCReconfigurationSidelink #1 912. In some embodiments, the second terminal device 120 may determine whether the configuration information of RLC channel for the first hop is successfully configured. In the context of FIG. 9, it is assumed that the configuration information of RLC channel for the first hop is successfully configured.

The second terminal device 120 transmits 920 a second RRC reconfiguration sidelink message (i.e., RRCReconfigurationSidelink #2 shown in FIG. 9) 922 to the third terminal device 130. The RRCReconfigurationSidelink #2 922 includes configuration information of RLC channel for the second hop.

The third terminal device 130 receives 924 RRCReconfigurationSidelink #2 922. In some embodiments, the third terminal device 130 may determine whether the configuration information of RLC channel for the second hop is successfully configured. In the context of FIG. 9, it is assumed that the configuration information of RLC channel for the second hop is successfully configured.

The third terminal device 130 transmits 930 a first RRC reconfiguration complete Sidelink message (i.e., RRCReconfigurationCompleteSidelink #2 shown in FIG. 9) 932 to the second terminal device 120. The RRCReconfigurationCompleteSidelink #2 932 indicates that the configuration for the second hop is successful.

The second terminal device 120 receives 934 RRCReconfigurationComplete Sidelink #2 932. In some embodiments, a first timer is started at the second terminal device 120 while transmitting RRCReconfigurationSidelink #2 922, and RRC ReconfigurationCompleteSidelink #2 932 is received before the first timer lapses.

The second terminal device 120 transmits 940 a second RRC reconfiguration complete sidelink message (i.e., RRCReconfigurationCompleteSidelink #1 shown in FIG. 9) 942 to the first terminal device 110. Accordingly, the first terminal device 110 receives 944 RRCReconfigurationCompleteSidelink #1 942. In some embodiments, a second timer is started at the first terminal device 110 while transmitting RRCReconfigurationSidelink #1 912, and RRCReconfigurationCompleteSidelink #1 942 is received before the second timer lapses.

In some embodiments, RRCReconfigurationCompleteSidelink #1 942 may indicate successful configurations for both the first hop and the second hop.

In some embodiments, RRCReconfigurationCompleteSidelink #1 942 may indicate a successful configuration for the first hop, and alternatively or additionally, the second terminal device 120 transmits 940 status information 952 to indicate the configuration for the second hop. Accordingly, the first terminal device 110 receives 954 the status information 952 to indicate the configuration for the second hop. In this case, RRCReconfigurationCompleteSidelink #1 942 may be transmitted before or after the transmission of RRCReconfigurationSidelink #2 922, or be transmitted after receiving RRCReconfigurationCompleteSidelink #2 932.

Additionally, E2E configuration may be transmitted from the first terminal device 110 to the third terminal device 130. In some embodiments, the first terminal device 110 may transmit 901 E2E configuration 902 to the third terminal device 130 before the transmission of RRCReconfigurationSidelink #1 912. Accordingly, the third terminal device 130 may receive 904 the E2E configuration 902. In this event, the E2E configuration may be performed first. In some other embodiments, the first terminal device 110 may transmit 961 E2E configuration 902 to the third terminal device 130 if the configurations for the first and the second hops are successful. Accordingly, the third terminal device 130 may receive 964 the E2E configuration 902. In this event, the per-hop configuration may be performed first, and the configuration feedback information indicating both successful of the first hop and second hop configurations can trigger the first terminal device 110 to configure E2E SLRB.

It is to be understood that the description with reference to FIG. 9 is for a case that the configurations for both hops are successful; however, there may be some case that the per-hop configuration may be failed.

FIG. 10 illustrates a signalling chart illustrating configuring process 1000 according to some example embodiments of the present disclosure.

The first terminal device 110 transmits 1010 a first RRC reconfiguration sidelink message (i.e., RRCReconfigurationSidelink #1 shown in FIG. 10) 1012 to the second terminal device 120. The RRCReconfigurationSidelink #1 1012 includes configuration information of RLC channel for the first hop, and includes configuration information of RLC channel for the second hop and/or QoS related information for the second hop.

Alternatively of additionally, in some embodiments, the first terminal device 110 may transmit 1001 E2E configuration 1002 to the third terminal device 130 before the transmission of RRCReconfigurationSidelink #1 1012. Accordingly, the third terminal device 130 may receive 1004 the E2E configuration 1002.

On the other side of communication, the second terminal device 120 receives 1014 RRCReconfigurationSidelink #1 1012. In some embodiments, the second terminal device 120 may determine whether the configuration information of RLC channel for the first hop is successfully configured. In the context of FIG. 10, it is assumed that the configuration information of RLC channel for the first hop is successfully configured.

Alternatively of additionally, in some embodiments, the second terminal device 120 may transmit 1015 RRCReconfigurationCompleteSidelink #1 1016 to the first terminal device 110. The RRCReconfigurationCompleteSidelink #1 1016 indicates that the first hop configuration is successful. Accordingly, the first terminal device 110 receives 1017 RRCReconfigurationCompleteSidelink #1 1016.

The second terminal device 120 transmits 1020 a second RRC reconfiguration Sidelink message (i.e., RRCReconfigurationSidelink #2 shown in FIG. 10) 1022 to the third terminal device 130. The RRCReconfigurationSidelink #2 1022 includes configuration information of RLC channel for the second hop.

Alternatively or additionally, the second terminal device 120 may start a first timer with a first time length (T1) while transmitting RRCReconfigurationSidelink #2 1022.

The third terminal device 130 receives 1024 RRCReconfigurationSidelink #2 1022. In some embodiments, the third terminal device 130 may determine whether the configuration information of RLC channel for the second hop is successfully configured. In the context of FIG. 10, it is assumed that the configuration of RLC channel for the second hop is failed.

The third terminal device 130 transmits 1030 a first RRC reconfiguration failure Sidelink message (i.e., RRCReconfigurationFailureSidelink #2 shown in FIG. 10) 1032 to the second terminal device 120. The RRCReconfigurationFailureSidelink #2 1032 indicates that the configuration for the second hop is failed.

The second terminal device 120 receives 1034 RRCReconfigurationFailure Sidelink #2 1032. In some embodiments, a first timer is started at the second terminal device 120 while transmitting RRCReconfigurationSidelink #2 1022, and RRC ReconfigurationFailureSidelink #2 1032 is received before the first timer lapses or expires. Alternatively or additionally, the second terminal device 120 may stop the first timer upon receiving RRC ReconfigurationFailureSidelink #2 1032.

The second terminal device 120 may determine 1036 whether to retry the reconfiguration of the second hop.

In some embodiments, the second terminal device 120 determines to retry only if the first hop is configured successfully. In some embodiments, if the second terminal device 120 has received an indication of the second terminal device 120 is allowed to retry, the second terminal device 120 determines to retry. In some embodiments, if a set of retry reconfiguration for the first channel has been indicated by the first terminal device 110, the second terminal device 120 determines to retry.

In some other embodiments, the second terminal device 120 determines not to retry if the configuration for the first hop is failed. In some embodiments, if the second terminal device 120 has received an indication of the second terminal device 120 is not allowed to retry, the second terminal device 120 determines not to retry.

It is assumed that the second terminal device 120 determines to retry in the embodiments shown in FIG. 10.

In some example embodiments, the second terminal device 120 may perform the reconfiguration of the second hop up to N times (i.e. a maximum number of retries). In some examples, N is indicated by the first terminal device 110, is configured by the network device 122, or is determined by the second terminal device 120 based on its implementation. N is an integer, such as 1, 2, . . . .

In some example embodiments, the second terminal device 120 transmits 1040 RRCReconfigurationSidelink #2/ #3 1042 to the third terminal device 130. In some examples, same first reconfiguration (RRCReconfigurationSidelink #2) may be used for retrying, or different reconfiguration (RRCReconfigurationSidelink #3) may be used for retrying. For example, if a set of retry reconfiguration for the first channel has been indicated by the first terminal device 110, the second terminal device 120 may use corresponding retry reconfiguration (RRCReconfigurationSidelink #3) from the indicated set of retry reconfiguration. As another example, the second terminal device 120 may regenerate a different reconfiguration (RRCReconfigurationSidelink #3) based on the previous received at least one QoS parameter or QOS related information.

Alternatively or additionally, the second terminal device 120 may start a third timer with a third time length (represented as T3) while transmitting RRCReconfigurationSidelink #2/ #3 1042. In some examples, the second terminal device 120 may determine the third time length (T3) shorter than the precious T1. As another example, T3 may be the same as the precious T1.

In some example embodiments, for each retry of reconfigurations, the second terminal device 120 may reselect or determine a timer with a shorter time length than the previous one. In this regard, a less delay is introduced comparing to using a fixed time length for each retry.

On the other side of communication, the third terminal device 130 receives 1044 RRCReconfigurationSidelink #2/ #3 1042. It is assumed that the retried reconfiguration for the second hop is still failed.

The third terminal device 130 transmits 1050 RRCReconfigurationFailure Sidelink #2/ #3 1052 to the second terminal device 120. The RRCReconfigurationFailure Sidelink #2/ #3 1052 indicates that the configuration for the second hop is failed. Accordingly, the second terminal device 120 receives 1054 RRCReconfigurationFailure Sidelink #2/ #3 1052.

It is understood that the second terminal device 120 may perform further operations similar as 1036 and 1042, and will not be described for brief.

The second terminal device 120 transmits 1060 RRCReconfigurationFailure Sidelink #1 1062 to the first terminal device 110. In some embodiments, if the maximum number of retries (N) is reached and the second terminal device 120 does not receive a RRCReconfigurationCompleteSidelink message from the third terminal device 130 yet, the RRCReconfigurationFailureSidelink #1 1062 may be transmitted. Accordingly, the first terminal device 110 receives 1064 RRCReconfigurationFailureSidelink #1 1062. In some embodiments, a second timer is started at the first terminal device 110 while transmitting RRCReconfigurationSidelink #1 1012, and the second timer may be stopped upon the reception of RRCReconfigurationFailureSidelink #1 1062.

In some embodiments, RRCReconfigurationFailureSidelink #1 1062 may indicate that the second hop configuration is failed.

In some embodiments, RRCReconfigurationFailureSidelink #1 1062 may indicate that the first hop configuration is successful and the second hop configuration is failed.

It is understood that only once retry is shown in FIG. 10, however, there may be more retries in reality and the description in FIG. 10 is given for the purpose of illustration without suggesting any limitations to the present disclosure.

It is to be understood that the second terminal device 120 may transmit 1060 RRCReconfiguraionFailureSidelink #1 1062 to the first terminal device 110 if a determination that not to retry is made at 1036. Those skilled in the art would understand the specific implementation and detailed embodiment will not be described herein.

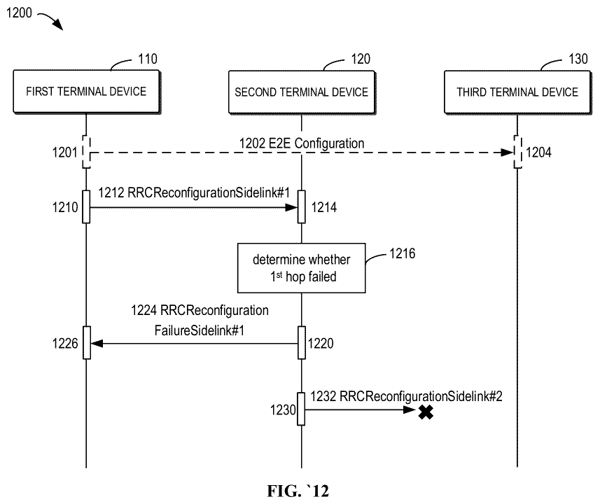

FIG. 11 illustrates a signalling chart illustrating configuring process 1100 according to some example embodiments of the present disclosure.

The first terminal device 110 transmits 1110 a first RRC reconfiguration Sidelink message (i.e., RRCReconfigurationSidelink #1 shown in FIG. 11) 1112 to the second terminal device 120. The RRCReconfigurationSidelink #1 1112 includes configuration information of RLC channel for the first hop, and includes configuration information of RLC channel for the second hop and/or QoS related information for the second hop.

Alternatively of additionally, in some embodiments, the first terminal device 110 may transmit 1101 E2E configuration 1102 to the third terminal device 130 before the transmission of RRCReconfigurationSidelink #1 1112. Accordingly, the third terminal device 130 may receive 1104 the E2E configuration 1102.

Alternatively of additionally, in some embodiments, the first terminal device 110 may transmit 1105 information for timer 1106 to the second terminal device 120. Accordingly, the second terminal device 120 receives 1107 the information for timer 1106. The information 1106 is used for the second terminal device 120 to determine the first time length for the first timer later. In some embodiments, the information 1106 may indicate the first time length or multiple time lengths.

On the other side of communication, the second terminal device 120 receives 1114 RRCReconfigurationSidelink #1 1112. In some embodiments, the second terminal device 120 may determine whether the configuration information of RLC channel for the first hop is successfully configured. In the context of FIG. 11, it is assumed that the configuration information of RLC channel for the first hop is successfully configured.

Alternatively of additionally, in some embodiments, the second terminal device 120 may transmit 1115 RRCReconfigurationCompleteSidelink #1 1116 to the first terminal device 110. The RRCReconfigurationCompleteSidelink #1 1116 indicates that the first hop configuration is successful. Accordingly, the first terminal device 110 receives 1117 RRCReconfigurationCompleteSidelink #1 1116.

The second terminal device 120 determines 1118 a value of a timer, for example a first timer with a first time length (i.e. T1).

The second terminal device 120 transmits 1120 a second RRC reconfiguration Sidelink message (i.e., RRCReconfigurationSidelink #2 shown in FIG. 11) 1122 to the third terminal device 130. The RRCReconfigurationSidelink #2 1122 includes configuration information of RLC channel for the second hop. The second terminal device 120 starts the first timer while transmitting RRCReconfigurationSidelink #2 1122.

On the other side of the communication, the third terminal device 130 may receive 1124 RRCReconfigurationSidelink #2 1122.

The second terminal device 120 determines 1125 that the first time length is reached. Specifically, the time lapses or expires but no feedback is received from the third terminal device 130.

The second terminal 120 transmits 1130 an RLF report 1132 to the first terminal device 110. In some embodiments, the RLF report 1132 includes the ID of the third terminal device 130. The ID of the third terminal device 130 may be represented as an RX UE ID (e.g. Layer 2 ID), a pair of RX UE ID and TX UE ID, or link ID corresponding to the RX UE or the pair of TX UE and RX UE. Accordingly, the first terminal device 110 receives 1134 the RLF report 1132. In this case, the RLF 1132 is transmitted upon a timeout is determined.

According to the embodiments described with reference to FIG. 10 to FIG. 11, the second terminal device 120 may handle the failure of the second hop configuration (such as retrying or reporting RLF) and the first terminal device 110 may be aware of the failure.

FIG. 12 illustrates a signalling chart illustrating configuring process 1200 according to some example embodiments of the present disclosure.

The first terminal device 110 transmits 1210 a first RRC reconfiguration Sidelink message (i.e., RRCReconfigurationSidelink #1 shown in FIG. 12) 1212 to the second terminal device 120. The RRCReconfigurationSidelink #1 1212 includes configuration information of RLC channel for the first hop, and includes configuration information of RLC channel for the second hop and/or QoS related information for the second hop.

Alternatively of additionally, in some embodiments, the first terminal device 110 may transmit 1201 E2E configuration 1202 to the third terminal device 130 before the transmission of RRCReconfigurationSidelink #1 1212. Accordingly, the third terminal device 130 may receive 1204 the E2E configuration 1202.

On the other side of communication, the second terminal device 120 receives 1214 RRCReconfigurationSidelink #1 1212. The second terminal device 120 determines 1216 whether the configuration information of RLC channel for the first hop is successfully configured. In the context of FIG. 12, it is assumed that the first hop configuration is failed.

The second terminal device 120 transmits 1220 RRCReconfigurationFailure Sidelink #1 1224 to the first terminal device 110. Accordingly, the first terminal device 110 receives 1226 RRCReconfigurationFailure Sidelink #1 1224.

The second terminal device 120 does not transmit 1230 RRCReconfiguration Sidelink #2 1232, or may suspends the transmission of RRCReconfigurationSidelink #2 1232. According to the embodiments described with reference to FIG. 12, the second terminal device 120 may ignore or cancel the second hop configuration if the first hop configuration is failed. Thus the signalling overhead can be reduced.

FIG. 13 illustrates a signalling chart illustrating configuring process 1300 according to some example embodiments of the present disclosure.

The first terminal device 110 transmits 1310 a first RRC reconfiguration Sidelink message (i.e., RRCReconfigurationSidelink #1 shown in FIG. 13) 1312 to the second terminal device 120. The RRCReconfigurationSidelink #1 1312 includes configuration information of RLC channel for the first hop, and includes configuration information of RLC channel for the second hop and/or QoS related information for the second hop.

Alternatively of additionally, in some embodiments, the first terminal device 110 may transmit 1301 E2E configuration 1302 to the third terminal device 130 before the transmission of RRCReconfigurationSidelink #1 1312. Accordingly, the third terminal device 130 may receive 1304 the E2E configuration 1302.

On the other side of communication, the second terminal device 120 receives 1314 RRCReconfigurationSidelink #1 1312.

The second terminal device 120 transmits 1320 RRCReconfigurationSidelink #2 1322 to the third terminal device 1324 upon reception of RRCReconfigurationSidelink #1 1312. Accordingly, the third terminal device 130 receives 1324 RRCReconfiguration Sidelink #2 1322.

The second terminal device 120 determines 1326 whether the configuration information of RLC channel for the first hop is successfully configured. In the context of FIG. 13, it is assumed that the first hop configuration is failed.

The second terminal device 120 transmits 1330 RRCReconfigurationFailure Sidelink #1 1334 to the first terminal device 110. Accordingly, the first terminal device 110 receives 1336 RRCReconfigurationFailureSidelink #1 1334.

Alternatively or additionally, the second terminal device 120 may handle 1340 the second hop configuration.

In some example embodiments, if the first timer is started while transmitting RRCReconfiguration Sidelink #2 1322, the second terminal device 120 may stop the first timer upon the determination that the first hop configuration is failed. Alternatively or additionally, the first timer is kept even if the first hop configuration is failed.

In some example embodiments, the second terminal device 120 does not expect any report on a state of the second hop configuration from the third terminal device 130.

In some example embodiments, the second terminal device 120 receives a report on a state of the second hop configuration (successful or failed) from the third terminal device 130, but does not report the failure of the second hop configuration to the first terminal device 110. Alternatively or additionally, the second terminal device 120 may not process or interpret the received state of the second hop configuration. In other words, the second terminal device 120 may ignore or cancel the received state of the second hop configuration. Alternatively or additionally, the second terminal device 120 does not report the RLF detected (for example, determined based on an expiry of the first timer) on the second hop to the first terminal device 110.

In some example embodiments, the second terminal device 120 receives a report on a state of the second hop configuration (successful or failed) from the third terminal device 130, and the second terminal device 120 transmits a failure message to the first terminal device 110. The failure message may be a different one from those described above, for example, the failure message may be RRCReconfigurationFailureSidelink #4. It is noted that the failure message may be transmitted through RRC signalling, a MAC CE or an SCI. The present disclosure does not limit this aspect.

In some example embodiments, the second terminal device 120 transmits a RLF report to the first terminal device 110 upon a timeout of the first timer, regardless of reception of a on a state of the second hop configuration from the third terminal device 130.

According to the embodiments described with reference to FIG. 13, the second terminal device 120 may handle the second hop configuration in case the first hop configuration is failed.

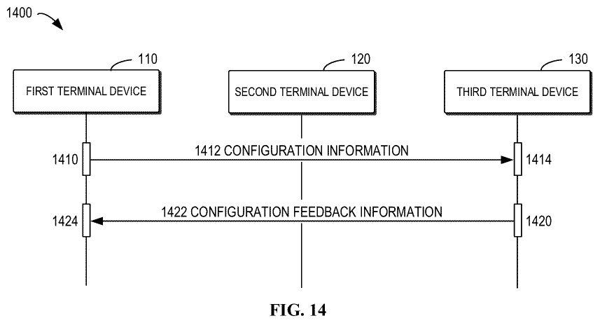

FIG. 14 illustrates a signalling chart illustrating configuring process 1400 according to some example embodiments of the present disclosure.

The first terminal device 110 transmits 1410 configuration information 1412 to the second terminal device 120. The configuration information 1412 indicates E2E configuration for bearer between the first terminal device 110 and the third terminal device 130 and a first reconfiguration for the first channel between the second terminal device 120 and the third terminal device 130.

In some embodiments, the configuration information 1412 may be transmitted through any message or signalling. For example, the configuration information 1412 may be transmitted through PC5-RRC signalling. In some embodiments, the E2E configuration may be called as configuration of E2E SLRB (for example, it consists of at least the configuration of SDAP or PDCP for this E2E SLRB) and this disclosure does not limit this aspect.

On the other side of communication, the third terminal device 130 receives 1414 configuration information 1412. Alternatively or additionally, the third terminal device 130 may determine whether the E2E configuration is successful and/or whether the second configuration is successful.

The third terminal device 130 transmits 1420 configuration feedback information 1422 to the first terminal device 110. The configuration feedback information 1422 may indicates whether the E2E configuration is successful and/or whether the second configuration is successful.

In some embodiments, the configuration feedback information 1422 may be transmitted through any message or signalling. For example, the configuration feedback information 1422 may be carried in PC5-RRC signallig.

On the other side of communication, the first terminal device 110 receives 1424 configuration feedback information 1422.

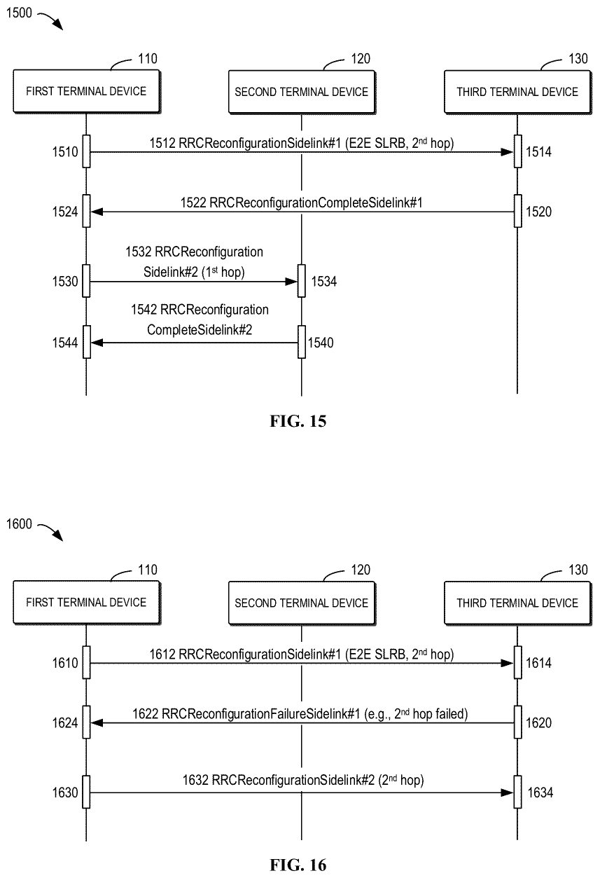

It is assumed that the configuration information 1412 is transmitted through an RRCReconfigurationSidelink message and the configuration feedback information 1422 is transmitted through an RRCReconfigurationCompleteSidelink message or an RRCReconfigurationFailureSidelink message. Example embodiments related to these specific messages will be further detailed hereinafter with reference to FIGS. 15-16.

FIG. 15 illustrates a signalling chart illustrating configuring process 1500 according to some example embodiments of the present disclosure.

The first terminal device 110 transmits 1510 RRCReconfigurationSidelink #1 1512 to the second terminal device 120. The RRCReconfigurationSidelink #1 1512 comprises E2E configuration and the second hop configuration.

On the other side of communication, the third terminal device 130 receives 1514 RRCReconfigurationSidelink #1 1512. Alternatively or additionally, the third terminal device 130 may determine whether the E2E configuration is successful and/or whether the second configuration is successful. In the context of FIG. 15, it is assumed that both the E2E configuration and the second configuration are successful.

The third terminal device 130 transmits 1520 RRCReconfigurationComplete Sidelink #1 1522 to the first terminal device 110. The RRCReconfigurationComplete Sidelink #1 1522 may indicate that both the E2E configuration and the second configuration are successful.

On the other side of communication, the first terminal device 110 receives 1524 RRCReconfigurationCompleteSidelink #1 1522.

The first terminal device 110 transmits 1530 RRCReconfigurationSidelink #2 1532 to the second terminal device 120. The RRCReconfigurationSidelink #2 1532 includes the first hop configuration.

On the other side of communication, the second terminal device 120 receives 1534 RRCReconfigurationSidelink #2 1532. Alternatively or additionally, the second terminal device 120 may determine whether the first configuration is successful. In the context of FIG. 15, it is assumed that the first configuration is successful.

The second terminal device 120 transmits 1540 RRCReconfigurationCompleteSidelink #2 1542 to the first terminal device 110. On the other side of communication, the first terminal device 110 receives 1544 RRCReconfigurationCompleteSidelink #2 1542.

FIG. 16 illustrates a signalling chart illustrating configuring process 1600 according to some example embodiments of the present disclosure.

The first terminal device 110 transmits 1610 RRCReconfigurationSidelink #1 1612 to the second terminal device 120. The RRCReconfigurationSidelink #1 1612 comprises E2E configuration and the second hop configuration.

On the other side of communication, the third terminal device 130 receives 1614 RRCReconfigurationSidelink #1 1612. Alternatively or additionally, the third terminal device 130 may determine whether the E2E configuration is successful and/or whether the second configuration is successful. In the context of FIG. 16, it is assumed that the E2E configuration is successful and the second configuration is failed.

The third terminal device 130 transmits 1620 RRCReconfigurationFailure Sidelink #1 1622 to the first terminal device 110. The RRCReconfigurationFailure Sidelink #1 1622 may indicate that the E2E configuration is successful and the second configuration is failed.

On the other side of communication, the first terminal device 110 receives 1624 RRCReconfigurationFailureSidelink #1 1622.

The first terminal device 110 transmits 1630 RRCReconfigurationSidelink #2 1632 to the third terminal device 130. The RRCReconfigurationSidelink #2 1632 comprises the second hop configuration. In this way, the first terminal device 110 can reconfigure the second hop based on a feedback from the third terminal device 130.

It should be appreciated that further operations may be included in the example embodiments in FIG. 16, those skilled in the art would understand that the description in FIG. 16 is given for the purpose of illustration without suggesting any limitations.

According to the embodiments described with reference to FIG. 6 to FIG. 16, the relay UE may handle failure of per-hop configuration and report to the TX UE, in this regard, TX UE may be aware of configuration state for per-hop, in some cases, the TX UE may perform further operations to handle the failed configuration and thus the efficiency can be improved.

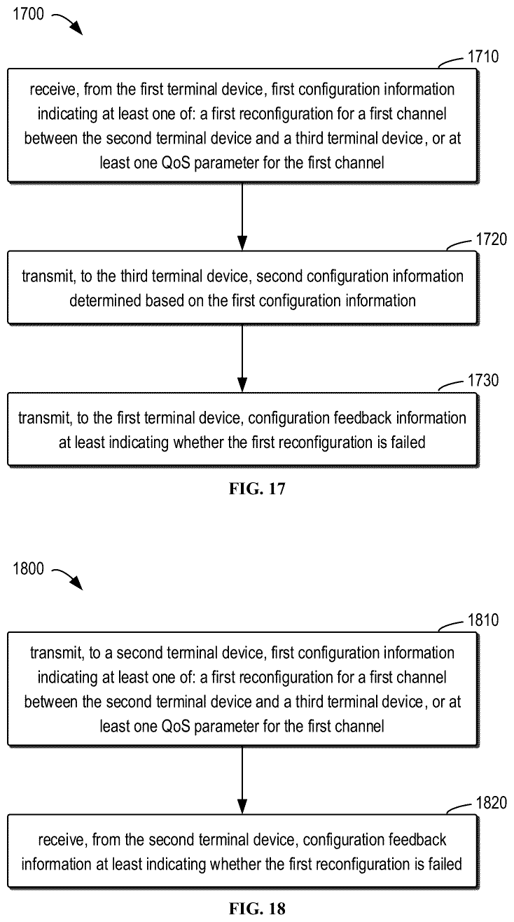

FIG. 17 illustrates a flowchart of an example method 1700 implemented at a second terminal device in accordance with some embodiments of the present disclosure. For the purpose of discussion, the method 1700 will be described from the perspective of the second terminal device 120 with reference to FIG. 1.

At block 1710, the second terminal device 120 receives, from the first terminal device 110, first configuration information indicating at least one of: a first reconfiguration for a first channel between the second terminal device 120 and a third terminal device 130, or at least one quality of service (QOS) parameter for the first channel. At block 1720, the second terminal device 120 transmits, to the third terminal device 130, second configuration information determined based on the first configuration information. At block 1730, the second terminal device 120 transmits, to the first terminal device 110, configuration feedback information at least indicating whether the first reconfiguration is failed.

In some example embodiments, the method 1700 further comprises: in accordance with a determination that the first configuration information does not indicate the first reconfiguration for the first channel, the second terminal device 120 generates the first reconfiguration for the first channel based on the at least one QoS parameter, where the second configuration information indicates the first reconfiguration.

In some example embodiments, the method 1700 further comprises: the second terminal device 120 determines that the first reconfiguration is failed in accordance with one of the following: reception of configuration failure information from the third terminal device 130, a maximum number of retries being reached, the retries being performed for retrying reconfiguration of the first channel, expiry of a first timer being started while transmitting the second configuration information, or a second reconfiguration for a second channel between the first terminal device 110 and the second terminal device 120 being failed.

In some example embodiments, the maximum number of retries is one of the following: indicated by the first terminal device 110, wherein the maximum number of retries is determined by the first terminal device 110 or configured by a network device, or determined by the second terminal device 120 based on the at least one QoS parameter.

In some example embodiments, a first time length of the first timer is indicated by the first terminal device 110 or determined by the second terminal device 120.

In some example embodiments, the first configuration information further indicates a set of retry reconfigurations for the first channel. The method 1700 further comprises: in accordance with a determination that the first reconfiguration is failed, the second terminal device 120 retries reconfiguration for the first channel for up to the maximum number based on the set of retry reconfigurations.

In some example embodiments, the retrying is further in accordance with a determination that the second reconfiguration is successful.

In some example embodiments, the method 1700 further comprises: the second terminal device 120 receives, from the first terminal device 110, an indication comprising at least one of: the first time length, multiple time lengths comprising the first time length, a second time length of a second timer exceeding the first time length, or a set of time lengths corresponding to a set of terminal devices comprising the first terminal device 110 or the third terminal device 130. The indication is comprised in the first configuration information or transmitted separately from the first configuration information.

In some example embodiments, at least one of the first timer or the second timer is specific to a configuration of relay traffic between the first terminal device 110 and the third terminal device 130.

In some example embodiments, the first configuration information further indicates a second reconfiguration for a second channel between the first terminal device 110 and the second terminal device 120.

In some example embodiments, transmitting the second configuration information comprises: in accordance with a determination that the second reconfiguration is successful, transmitting the second configuration information.

In some example embodiments, the method 1700 further comprises: the second terminal device 120 transmits, to the first terminal device 110, configuration complete information indicating that the second reconfiguration is successful.

In some example embodiments, the method 1700 further comprises: in accordance with a determination that the second reconfiguration is failed, the second terminal device 120 performs one of: ceasing transmitting the second configuration information, ignoring the second configuration information by stopping a first timer, ignoring a report on whether the first reconfiguration is failed from the third terminal device 130, ceasing transmitting the configuration feedback information, or transmitting, to the first terminal device 110, a failure report indicating that the second reconfiguration is failed.

In some example embodiments, the failure report is a radio link failure (RLF) message or a radio resource control (RRC) reconfiguration failure message, and wherein the failure report is transmitted through at least one of: PC5-RRC signalling, a medium access control (MAC) control element (CE), or sidelink control information (SCI).

In some example embodiments, the configuration feedback information further indicates at least one of: whether the second reconfiguration is failed, an identifier of a sidelink between the first terminal device 110 and the second terminal device 120, an identifier of a sidelink between the second terminal device 120 and the third terminal device 130, or a bit map indicating whether each of the first reconfiguration and the second reconfiguration is failed.

In some example embodiments, the first channel comprises a radio link control (RLC) channel between the second terminal device 120 and the third terminal device 130, and the second channel comprises an RLC channel between the first terminal device 110 and the second terminal device 120.

In some example embodiments, the method 1700 further comprises: the second terminal device 120 transmits the at least one QoS parameter to a serving network device of the second terminal device 120.

In some example embodiments, the method 1700 further comprises: in accordance with a connection establishment between the first terminal device 110 and the third terminal device 130 or a connection establishment between the first terminal device 110 and the second terminal device 120, the second terminal device 120 transmits assistance information to the first terminal device 110 prior to reception of the first configuration information, the assistance information indicating at least one of: an identifier of the third terminal device 130, QoS assistance information, or traffic load information, where the assistance information is transmitted through PC5-RRC signalling.

In some example embodiments, the assistance information is forwarded from the third terminal device 130 to the first terminal device 110.

In some example embodiments, the at least one QoS parameter comprises at least one of the following: a PC5 5QI (PQI), a set of QoS parameters indicating a PQI, a PC5 flow bit rate, a resource type, a priority level, a packet delay budget, a packet error rate, a maximum data burst volume and an averaging window, or at least one pair of PQI and corresponding application indicated priority.

In some example embodiments, the first configuration information, the second configuration information, or the configuration feedback information is transmitted through at least one of: PC5-RRC signalling, a MAC CE, or an SCI.

FIG. 18 illustrates a flowchart of an example method 1800 implemented at a first terminal device 110 in accordance with some embodiments of the present disclosure. For the purpose of discussion, the method 1800 will be described from the perspective of the first terminal device 110 with reference to FIG. 1.

At block 1810, the first terminal device 110 transmits, to a second terminal device 120, first configuration information indicating at least one of: a first reconfiguration for a first channel between the second terminal device 120 and a third terminal device 130, or at least one quality of service (QOS) parameter for the first channel. At block 1820, the first terminal device 110 receives, from the second terminal device 120, configuration feedback information at least indicating whether the first reconfiguration is failed.

In some example embodiments, the method 1800 further comprises: the first terminal device 110 transmits, to the second terminal device 120, an indication comprising at least one of: a first time length, multiple time lengths comprising the first time length, a second time length of a second timer exceeding the first time length, or a set of time lengths corresponding to a set of terminal devices comprising the first terminal device 110 or the third terminal device 130, where the indication is comprised in the first configuration information or transmitted separately from the first configuration information.

In some example embodiments, at least one of the first timer or the second timer is specific to relay traffic between the first terminal device 110 and the third terminal device 130.

In some example embodiments, the first configuration information further indicates a set of retry reconfigurations for retrying the first reconfiguration of the first channel by the second terminal device 120.

In some example embodiments, the first configuration information further indicates a second reconfiguration for a second channel between the first terminal device 110 and the second terminal device 120.

In some example embodiments, the method further comprises: receiving, from the second terminal device 120, configuration complete information indicating that the second reconfiguration is successful.

In some example embodiments, the method 1800 further comprises: the first terminal device 110 receives, from the second terminal device 120, a failure report indicating that the second reconfiguration is failed.

In some example embodiments, the failure report is a radio link failure (RLF) message or a radio resource control (RRC) reconfiguration failure message, and wherein the failure report is transmitted through at least one of: PC5-RRC signalling, a medium access control (MAC) control element (CE), or sidelink control information (SCI).

In some example embodiments, the configuration feedback information further indicates at least one of: whether the second reconfiguration is failed, an identifier of a sidelink between the first terminal device 110 and the second terminal device 120, an identifier of a sidelink between the second terminal device 120 and the third terminal device 130, or a bit map indicating whether each of the first reconfiguration and the second reconfiguration is failed.

In some example embodiments, the first channel comprises a radio link control (RLC) channel between the second terminal device 120 and the third terminal device 130, and the second channel comprises an RLC channel between the first terminal device 110 and the second terminal device 120.

In some example embodiments, the method 1800 further comprises: the first terminal device 110 receives assistance information from the second terminal device 120 or the third terminal device 130 prior to transmission of the first configuration information, the assistance information indicating at least one of: an identifier of the third terminal device 130, QoS assistance information, or traffic load information, where the assistance information is transmitted through PC5-RRC signalling.

In some example embodiments, the method 1800 further comprises: the first terminal device 110 transmits, to the third terminal device 130 prior to transmission of the first configuration information, third configuration information indicating an end-to-end (E2E) configuration for bearer between the first terminal device 110 and the third terminal device 130, or in accordance with a determination that the first reconfiguration and a second reconfiguration for a second channel between the first terminal device 110 and the second terminal device 120 are successful, the first terminal device 110 transmits, to the third terminal device 130, third configuration information indicating the E2E configuration.

In some example embodiments, the at least one QoS parameter comprises at least one of the following: a PC5 5QI (PQI), a set of QoS parameters indicating a PQI, a PC5 flow bit rate, a resource type, a priority level, a packet delay budget, a packet error rate, a maximum data burst volume and an averaging window, or at least one pair of PQI and corresponding application indicated priority.

In some example embodiments, the first configuration information or the configuration feedback information is transmitted through at least one of: PC5-RRC signalling, a MAC CE, or an SCI.

FIG. 19 illustrates a flowchart of an example method 1900 implemented at a first terminal device 110 in accordance with some embodiments of the present disclosure. For the purpose of discussion, the method 1900 will be described from the perspective of the first terminal device 110 with reference to FIG. 1.

At block 1910, the first terminal device 110 transmits, to a third terminal device 130, first configuration information indicating: an end-to-end (E2E) configuration for bearer between the first terminal device 110 and the third terminal device 130, and a first reconfiguration for a first channel between a second terminal device 120 and the third terminal device 130. At block 1920, the first terminal device 110 receives, from the third terminal device 130, first configuration feedback information indicating at least one of: whether the first reconfiguration is failed, or whether the E2E configuration is failed.

In some example embodiments, the method 1900 further comprises: in accordance with the first configuration feedback information indicates both the first reconfiguration and the E2E configuration are successful, the first terminal device 110 transmits, to the second terminal device 120, second configuration information indicating a second reconfiguration for a second channel between the first terminal device 110 and the second terminal device 120; and the first terminal device 110 receives, from the second terminal device 120, second configuration feedback information indicating whether the second reconfiguration is failed.

In some example embodiments, the first channel comprises a radio link control (RLC) channel between the second terminal device 120 and the third terminal device 130, and the second channel comprises an RLC channel between the first terminal device 110 and the second terminal device 120.

In some example embodiments, the first configuration information or the first configuration feedback information is transmitted through PC5-radio resource control (PC5-RRC) signalling.

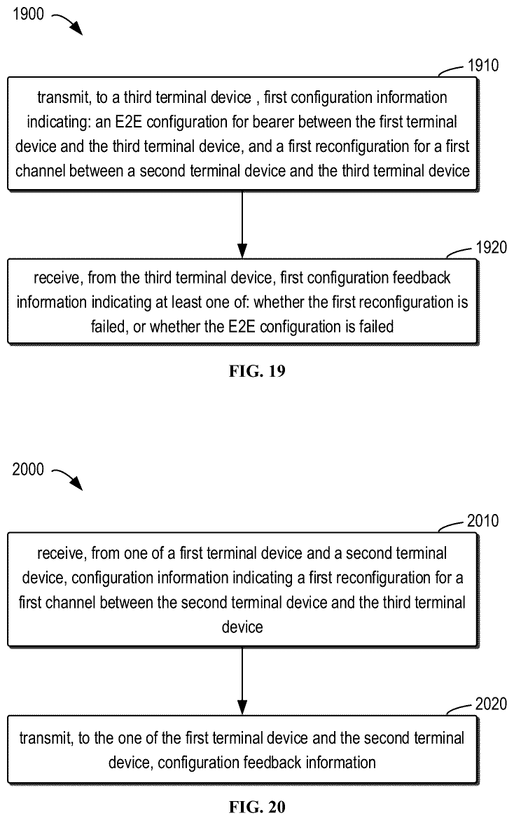

FIG. 20 illustrates a flowchart of an example method 2000 implemented at a third terminal device 130 in accordance with some embodiments of the present disclosure. For the purpose of discussion, the method 2000 will be described from the perspective of the third terminal device 130 with reference to FIG. 1.

At block 2010, the third terminal device 130 receives, from one of a first terminal device 110 and a second terminal device 120, configuration information indicating a first reconfiguration for a first channel between the second terminal device 120 and the third terminal device 130. At block 2020, the third terminal device 130 transmits, to the one of the first terminal device 110 and the second terminal device 120, configuration feedback information.

In some example embodiments, the configuration information is received from the first terminal device 110 and further indicates an end-to-end (E2E) configuration for a bearer between the first terminal device 110 and the third terminal device 130.

In some example embodiments, the configuration feedback information indicates at least one of: whether the first reconfiguration is failed, or whether the E2E configuration is failed.

In some example embodiments, the configuration information or the configuration feedback information is transmitted through PC5-radio resource control (PC5-RRC) signalling.

In some example embodiments, the configuration information is received from the second terminal device 120, and wherein the configuration feedback information indicates whether the first reconfiguration is failed.

In some example embodiments, the method 2000 further comprises: the third terminal device 130 transmits assistance information to the first terminal device 110 or to the second terminal device 120, the assistance information indicating at least one of: an identifier of the third terminal device 130, quality of service (QOS) assistance information, or traffic load information, where the assistance information is transmitted through PC5-RRC signalling.

In some example embodiments, the configuration information or the configuration feedback information is transmitted through at least one of: PC5-RRC signalling, a medium access control (MAC) control element (CE), or sidelink control information (SCI).

In some example embodiments, the first channel comprises a radio link control (RLC) channel between the second terminal device 120 and the third terminal device 130.

Details of some embodiments according to the present disclosure have been described with reference to FIGS. 1-20. Now an example implementation of the terminal devices will be discussed below.

In some example embodiments, a second terminal device comprises circuitry configured to: receive, from a first terminal device, first configuration information indicating at least one of: a first reconfiguration for a first channel between the second terminal device and a third terminal device, or at least one quality of service (QOS) parameter for the first channel; transmit, to the third terminal device, second configuration information determined based on the first configuration information; and transmit, to the first terminal device, configuration feedback information at least indicating whether the first reconfiguration is failed.

In some example embodiments, the second terminal device comprises circuitry configured to: in accordance with a determination that the first configuration information does not indicate the first reconfiguration for the first channel, generate the first reconfiguration for the first channel based on the at least one QoS parameter; where the second configuration information indicates the first reconfiguration.

In some example embodiments, the second terminal device comprises circuitry configured to: determine that the first reconfiguration is failed in accordance with one of the following: reception of configuration failure information from the third terminal device, a maximum number of retries being reached, the retries being performed for retrying reconfiguration of the first channel, expiry of a first timer being started while transmitting the second configuration information, or a second reconfiguration for a second channel between the first terminal device and the second terminal device being failed.

In some example embodiments, the maximum number of retries is one of the following: indicated by the first terminal device, wherein the maximum number of retries is determined by the first terminal device or configured by a network device, or determined by the second terminal device based on the at least one QoS parameter.

In some example embodiments, a first time length of the first timer is indicated by the first terminal device or determined by the second terminal device.

In some example embodiments, the first configuration information further indicates a set of retry reconfigurations for the first channel, and the second terminal device comprises circuitry configured to: in accordance with a determination that the first reconfiguration is failed, retry reconfiguration for the first channel for up to the maximum number based on the set of retry reconfigurations.

In some example embodiments, the second terminal device comprises circuitry configured to: in accordance with a determination that the second reconfiguration is successful to retry.

In some example embodiments, the second terminal device comprises circuitry configured to: receive, from the first terminal device, an indication comprising at least one of: the first time length, multiple time lengths comprising the first time length, a second time length of a second timer exceeding the first time length, or a set of time lengths corresponding to a set of terminal devices comprising the first terminal device or the third terminal device, where the indication is comprised in the first configuration information or transmitted separately from the first configuration information.

In some example embodiments, at least one of the first timer or the second timer is specific to a configuration of relay traffic between the first terminal device and the third terminal device.

In some example embodiments, the first configuration information further indicates a second reconfiguration for a second channel between the first terminal device and the second terminal device.

In some example embodiments, the second terminal device comprises circuitry configured to: in accordance with a determination that the second reconfiguration is successful, transmit the second configuration information.

In some example embodiments, the second terminal device comprises circuitry configured to: transmit, to the first terminal device, configuration complete information indicating that the second reconfiguration is successful.

In some example embodiments, the second terminal device comprises circuitry configured to: in accordance with a determination that the second reconfiguration is failed, perform one of: ceasing transmitting the second configuration information, ignoring the second configuration information by stopping a first timer, ignoring a report on whether the first reconfiguration is failed from the third terminal device, ceasing transmitting the configuration feedback information, or transmitting, to the first terminal device, a failure report indicating that the second reconfiguration is failed.

In some example embodiments, the failure report is a radio link failure (RLF) message or a radio resource control (RRC) reconfiguration failure message, and wherein the failure report is transmitted through at least one of: PC5-RRC signalling, a medium access control (MAC) control element (CE), or sidelink control information (SCI).

In some example embodiments, the configuration feedback information further indicates at least one of: whether the second reconfiguration is failed, an identifier of a sidelink between the first terminal device and the second terminal device, an identifier of a sidelink between the second terminal device and the third terminal device, or a bit map indicating whether each of the first reconfiguration and the second reconfiguration is failed.

In some example embodiments, the first channel comprises a radio link control (RLC) channel between the second terminal device and the third terminal device, and the second channel comprises an RLC channel between the first terminal device and the second terminal device.

In some example embodiments, the second terminal device comprises circuitry configured to: transmit the at least one QoS parameter to a serving network device of the second terminal device.

In some example embodiments, the second terminal device comprises circuitry configured to: in accordance with a connection establishment between the first terminal device and the third terminal device or a connection establishment between the first terminal device and the second terminal device, transmit assistance information to the first terminal device prior to reception of the first configuration information, the assistance information indicating at least one of: an identifier of the third terminal device, QoS assistance information, or traffic load information, where the assistance information is transmitted through PC5-RRC signalling.

In some example embodiments, the assistance information is forwarded from the third terminal device to the first terminal device.

In some example embodiments, the at least one QoS parameter comprises at least one of the following: a PC5 5QI (PQI), a set of QoS parameters indicating a PQI, a PC5 flow bit rate, a resource type, a priority level, a packet delay budget, a packet error rate, a maximum data burst volume and an averaging window, or at least one pair of PQI and corresponding application indicated priority.

In some example embodiments, the first configuration information, the second configuration information, or the configuration feedback information is transmitted through at least one of: PC5-RRC signalling, a MAC CE, or an SCI.

In some example embodiments, a first terminal device comprises circuitry configured to: transmit, to a second terminal device, first configuration information indicating at least one of: a first reconfiguration for a first channel between the second terminal device and a third terminal device, or at least one quality of service (QOS) parameter for the first channel; and receive, from the second terminal device, configuration feedback information at least indicating whether the first reconfiguration is failed.

In some example embodiments, the first terminal device comprises circuitry configured to: transmit, to the second terminal device, an indication comprising at least one of: a first time length, multiple time lengths comprising the first time length, a second time length of a second timer exceeding the first time length, or a set of time lengths corresponding to a set of terminal devices comprising the first terminal device or the third terminal device, where the indication is comprised in the first configuration information or transmitted separately from the first configuration information.

In some example embodiments, at least one of the first timer or the second timer is specific to a configuration of relay traffic between the first terminal device and the third terminal device.

In some example embodiments, the first configuration information further indicates a set of retry reconfigurations for retrying the first reconfiguration of the first channel by the second terminal device.

In some example embodiments, the first configuration information further indicates a second reconfiguration for a second channel between the first terminal device and the second terminal device.

In some example embodiments, the first terminal device comprises circuitry configured to: receive, from the second terminal device, configuration complete information indicating that the second reconfiguration is successful.

In some example embodiments, the first terminal device comprises circuitry configured to: receive, from the second terminal device, a failure report indicating that the second reconfiguration is failed.

In some example embodiments, the failure report is a radio link failure (RLF) message or a radio resource control (RRC) reconfiguration failure message, and wherein the failure report is transmitted through at least one of: PC5-RRC signalling, a medium access control (MAC) control element (CE), or sidelink control information (SCI).

In some example embodiments, the configuration feedback information further indicates at least one of: whether the second reconfiguration is failed, an identifier of a sidelink between the first terminal device and the second terminal device, an identifier of a sidelink between the second terminal device and the third terminal device, or a bit map indicating whether each of the first reconfiguration and the second reconfiguration is failed.

In some example embodiments, the first channel comprises a radio link control (RLC) channel between the second terminal device and the third terminal device, and the second channel comprises an RLC channel between the first terminal device and the second terminal device.

In some example embodiments, the first terminal device comprises circuitry configured to: receive, assistance information from the second terminal device or the third terminal device prior to transmission of the first configuration information, the assistance information indicating at least one of: an identifier of the third terminal device, QoS assistance information, or traffic load information, where the assistance information is transmitted through PC5-RRC signalling.

In some example embodiments, the first terminal device comprises circuitry configured to: transmit, to the third terminal device prior to transmission of the first configuration information, third configuration information indicating an end-to-end (E2E) configuration for bearer between the first terminal device and the third terminal device.

In some example embodiments, the first terminal device comprises circuitry configured to: in accordance with a determination that the first reconfiguration and a second reconfiguration for a second channel between the first terminal device and the second terminal device are successful, transmit, to the third terminal device, third configuration information indicating the E2E configuration.

In some example embodiments, the at least one QoS parameter comprises at least one of the following: a PC5 5QI (PQI), a set of QoS parameters indicating a PQI, a PC5 flow bit rate, a resource type, a priority level, a packet delay budget, a packet error rate, a maximum data burst volume and an averaging window, or at least one pair of PQI and corresponding application indicated priority.

In some example embodiments, the first configuration information or the configuration feedback information is transmitted through at least one of: PC5-RRC signalling, a MAC CE, or an SCI.

In some example embodiments, a first terminal device comprises circuitry configured to: transmit, to a third terminal device, first configuration information indicating: an end-to-end (E2E) configuration for bearer between the first terminal device and the third terminal device, and a first reconfiguration for a first channel between a second terminal device and the third terminal device; and receive, from the third terminal device, first configuration feedback information indicating at least one of: whether the first reconfiguration is failed, or whether the E2E configuration is failed.

In some example embodiments, the first terminal device comprises circuitry configured to: in accordance with the first configuration feedback information indicates both the first reconfiguration and the E2E configuration are successful, transmit, to the second terminal device, second configuration information indicating a second reconfiguration for a second channel between the first terminal device and the second terminal device; and receive, from the second terminal device, second configuration feedback information indicating whether the second reconfiguration is failed.

In some example embodiments, the first channel comprises a radio link control (RLC) channel between the second terminal device and the third terminal device, and the second channel comprises an RLC channel between the first terminal device and the second terminal device.

In some example embodiments, the first configuration information or the first configuration feedback information is transmitted through PC5-radio resource control (PC5-RRC) signalling.

In some example embodiments, a third terminal device comprises circuitry configured to: receive, from one of a first terminal device and a second terminal device, configuration information indicating a first reconfiguration for a first channel between the second terminal device and the third terminal device; and transmit, to the one of the first terminal device and the second terminal device, configuration feedback information.

In some example embodiments, the configuration information is received from the first terminal device and further indicates an end-to-end (E2E) configuration for a bearer between the first terminal device and the third terminal device.

In some example embodiments, the configuration feedback information indicates at least one of: whether the first reconfiguration is failed, or whether the E2E configuration is failed.

In some example embodiments, the configuration information or the configuration feedback information is transmitted through PC5-radio resource control (PC5-RRC) signalling.

In some example embodiments, the configuration information is received from the second terminal device, and wherein the configuration feedback information indicates whether the first reconfiguration is failed.

In some example embodiments, the third terminal device comprises circuitry configured to: transmit, assistance information to the first terminal device or to the second terminal device, the assistance information indicating at least one of: an identifier of the third terminal device, QoS assistance information, or traffic load information, where the assistance information is transmitted through PC5-RRC signalling.

In some example embodiments, the configuration information or the configuration feedback information is transmitted through at least one of: PC5-RRC signalling, a medium access control (MAC) control element (CE), or sidelink control information (SCI).

In some example embodiments, the first channel comprises a radio link control (RLC) channel between the second terminal device and the third terminal device.

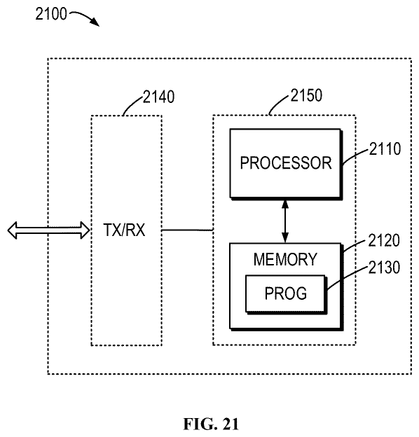

FIG. 21 illustrates a simplified block diagram of a device 2100 that is suitable for implementing embodiments of the present disclosure. The device 2100 can be considered as a further example implementation of the first terminal device 110, the second terminal device 120 and/or the third terminal device 130 as shown in FIG. 1. Accordingly, the device 2100 can be implemented at or as at least a part of the terminal device 110, or the network device 120.

As shown, the device 2100 includes a processor 2110, a memory 2120 coupled to the processor 2110, a suitable transmitter (TX) and receiver (RX) 2140 coupled to the processor 2110, and a communication interface coupled to the TX/RX 2140. The memory 2110 stores at least a part of a program 2130. The TX/RX 2140 is for bidirectional communications. The TX/RX 2140 has at least one antenna to facilitate communication, though in practice an Access Node mentioned in this disclosure may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 2130 is assumed to include program instructions that, when executed by the associated processor 2110, enable the device 2100 to operate in accordance with the embodiments of the present disclosure, as discussed herein with reference to FIGS. 6-20. The embodiments herein may be implemented by computer software executable by the processor 2110 of the device 2100, or by hardware, or by a combination of software and hardware. The processor 2110 may be configured to implement various embodiments of the present disclosure. Furthermore, a combination of the processor 2110 and memory 2120 may form processing means 2150 adapted to implement various embodiments of the present disclosure.

The memory 2120 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 2120 is shown in the device 2100, there may be several physically distinct memory modules in the device 2100. The processor 2110 may be of any type suitable to the local technical network, and may include one or more of general purpose computers, special purpose computers, microprocessors, digital signal processors (DSPs) and processors based on multicore processor architecture, as non-limiting examples. The device 2100 may have multiple processors, such as an application specific integrated circuit chip that is slaved in time to a clock which synchronizes the main processor.

In summary, embodiments of the present disclosure may provide the following solutions.

The present disclosure provides a method of communication, comprises: receiving, at a second terminal device and from a first terminal device, first configuration information indicating at least one of: a first reconfiguration for a first channel between the second terminal device and a third terminal device, or at least one quality of service (QOS) parameter for the first channel; transmitting, to the third terminal device, second configuration information determined based on the first configuration information; and transmitting, to the first terminal device, configuration feedback information indicating whether the first reconfiguration is failed.

In one embodiment, the method as above, further comprises: in accordance with a determination that the first configuration information does not indicate the first reconfiguration for the first channel, generating the first reconfiguration for the first channel based on the at least one QoS parameter; wherein the second configuration information indicates the first reconfiguration.

In one embodiment, the method as above, further comprises: determining that the first reconfiguration is failed in accordance with one of the following: reception of configuration failure information from the third terminal device, a maximum number of retries being reached, the retries being performed for retrying reconfiguration of the first channel, expiry of a first timer being started while transmitting the second configuration information, or a second reconfiguration for a second channel between the first terminal device and the second terminal device being failed.

In one embodiment, the method as above, the maximum number of retries is one of the following: indicated by the first terminal device, wherein the maximum number of retries is determined by the first terminal device or configured by a network device, or determined by the second terminal device based on the at least one QoS parameter.

In one embodiment, the method as above, a first time length of the first timer is indicated by the first terminal device or determined by the second terminal device.

In one embodiment, the method as above, the first configuration information further indicates a set of retry reconfigurations for the first channel, and wherein the method further comprises: in accordance with a determination that the first reconfiguration is failed, retrying reconfiguration for the first channel for up to the maximum number based on the set of retry reconfigurations.

In one embodiment, the method as above, the retrying is further in accordance with a determination that the second reconfiguration is successful.

In one embodiment, the method as above, further comprises: receiving, from the first terminal device, an indication comprising at least one of: a first time length for the first timer, multiple time lengths comprising the first time length, a second time length of a second timer exceeding the first time length, or a set of time lengths corresponding to a set of terminal devices comprising the first terminal device or the third terminal device, wherein the indication is comprised in the first configuration information or transmitted separately from the first configuration information.

In one embodiment, the method as above, at least one of the first timer or the second timer is specific to a configuration of relay traffic between the first terminal device and the third terminal device.

In one embodiment, the method as above, the first configuration information further indicates a second reconfiguration for a second channel between the first terminal device and the second terminal device.

In one embodiment, the method as above, transmitting the second configuration information comprises: in accordance with a determination that the second reconfiguration is successful, transmitting the second configuration information.

In one embodiment, the method as above, further comprises: transmitting, to the first terminal device, configuration complete information indicating that the second reconfiguration is successful.

In one embodiment, the method as above, further comprises: in accordance with a determination that the second reconfiguration is failed, performing one of: ceasing transmitting the second configuration information, ignoring the second configuration information by stopping a first timer, ignoring a report on whether the first reconfiguration is failed from the third terminal device, ceasing transmitting the configuration feedback information, or transmitting, to the first terminal device, a failure report indicating that the second reconfiguration is failed.

In one embodiment, the method as above, the failure report is a radio link failure (RLF) message or a radio resource control (RRC) reconfiguration failure message, and wherein the failure report is transmitted through at least one of: PC5-RRC signalling, a medium access control (MAC) control element (CE), or sidelink control information (SCI).

In one embodiment, the method as above, the configuration feedback information further indicates at least one of: whether the second reconfiguration is failed, an identifier of a sidelink between the first terminal device and the second terminal device, an identifier of a sidelink between the second terminal device and the third terminal device, or a bit map indicating whether each of the first reconfiguration and the second reconfiguration is failed.

In one embodiment, the method as above, the first channel comprises a radio link control (RLC) channel between the second terminal device and the third terminal device, and the second channel comprises an RLC channel between the first terminal device and the second terminal device.

In one embodiment, the method as above, further comprises: transmitting the at least one QoS parameter to a serving network device of the second terminal device.

In one embodiment, the method as above, further comprises: in accordance with a connection establishment between the first terminal device and the third terminal device or a connection establishment between the first terminal device and the second terminal device, transmitting assistance information to the first terminal device prior to reception of the first configuration information, the assistance information indicating at least one of: an identifier of the third terminal device, QoS assistance information, or traffic load information, wherein the assistance information is transmitted through PC5-RRC signalling.

In one embodiment, the method as above, the assistance information is forwarded from the third terminal device to the first terminal device.

In one embodiment, the method as above, the at least one QoS parameter comprises at least one of the following: a PC5 5QI (PQI), a set of QoS parameters indicating a PQI, a PC5 flow bit rate, a resource type, a priority level, a packet delay budget, a packet error rate, a maximum data burst volume and an averaging window, or at least one pair of PQI and corresponding application indicated priority.

In one embodiment, the method as above, the first configuration information, the second configuration information, or the configuration feedback information is transmitted through at least one of: PC5-RRC signalling, a MAC CE, or an SCI.

The present disclosure provides a method of communication, comprises: transmitting, at a first terminal device and to a second terminal device, first configuration information indicating at least one of: a first reconfiguration for a first channel between the second terminal device and a third terminal device, or at least one quality of service (QOS) parameter for the first channel; and receiving, from the second terminal device, configuration feedback information at least indicating whether the first reconfiguration is failed.

In one embodiment, the method as above, further comprises: transmitting, to the second terminal device, an indication comprising at least one of: a first time length, multiple time lengths comprising the first time length, a second time length of a second timer exceeding the first time length, or a set of time lengths corresponding to a set of terminal devices comprising the first terminal device or the third terminal device, wherein the indication is comprised in the first configuration information or transmitted separately from the first configuration information.

In one embodiment, the method as above, at least one of the first timer or the second timer is specific to a configuration of relay traffic between the first terminal device and the third terminal device.

In one embodiment, the method as above, the first configuration information further indicates a set of retry reconfigurations for retrying the first reconfiguration of the first channel by the second terminal device.

In one embodiment, the method as above, the first configuration information further indicates a second reconfiguration for a second channel between the first terminal device and the second terminal device.

In one embodiment, the method as above, further comprises: receiving, from the second terminal device, configuration complete information indicating that the second reconfiguration is successful.

In one embodiment, the method as above, further comprises: receiving, from the second terminal device, a failure report indicating that the second reconfiguration is failed.

In one embodiment, the method as above, the failure report is a radio link failure (RLF) message or a radio resource control (RRC) reconfiguration failure message, and wherein the failure report is transmitted through at least one of: PC5-RRC signalling, a medium access control (MAC) control element (CE), or sidelink control information (SCI).

In one embodiment, the method as above, the configuration feedback information further indicates at least one of: whether the second reconfiguration is failed, an identifier of a sidelink between the first terminal device and the second terminal device, an identifier of a sidelink between the second terminal device and the third terminal device, or a bit map indicating whether each of the first reconfiguration and the second reconfiguration is failed.

In one embodiment, the method as above, the first channel comprises a radio link control (RLC) channel between the second terminal device and the third terminal device, and the second channel comprises an RLC channel between the first terminal device and the second terminal device.

In one embodiment, the method as above, further comprises: receiving assistance information from the second terminal device or the third terminal device prior to transmission of the first configuration information, the assistance information indicating at least one of: an identifier of the third terminal device, QoS assistance information, or traffic load information, wherein the assistance information is transmitted through PC5-RRC signalling.

In one embodiment, the method as above, further comprises: transmitting, to the third terminal device prior to transmission of the first configuration information, third configuration information indicating an end-to-end (E2E) configuration for bearer between the first terminal device and the third terminal device, or in accordance with a determination that the first reconfiguration and a second reconfiguration for a second channel between the first terminal device and the second terminal device are successful, transmitting, to the third terminal device, third configuration information indicating the E2E configuration.

In one embodiment, the method as above, the at least one QoS parameter comprises at least one of the following: a PC5 5QI (PQI), a set of QoS parameters indicating a PQI, a PC5 flow bit rate, a resource type, a priority level, a packet delay budget, a packet error rate, a maximum data burst volume and an averaging window, or at least one pair of PQI and corresponding application indicated priority.

In one embodiment, the method as above, the first configuration information or the configuration feedback information is transmitted through at least one of: PC5-RRC signalling, a MAC CE, or an SCI.

The present disclosure provides a method of communication, comprises: transmitting, at a first terminal device and to a third terminal device, first configuration information indicating: an end-to-end (E2E) configuration for bearer between the first terminal device and the third terminal device, and a first reconfiguration for a first channel between a second terminal device and the third terminal device; and receiving, from the third terminal device, first configuration feedback information indicating at least one of: whether the first reconfiguration is failed, or whether the E2E configuration is failed.

In one embodiment, the method as above, further comprises: in accordance with the first configuration feedback information indicates both the first reconfiguration and the E2E configuration are successful, transmitting, to the second terminal device, second configuration information indicating a second reconfiguration for a second channel between the first terminal device and the second terminal device; and receiving, from the second terminal device, second configuration feedback information indicating whether the second reconfiguration is failed.

In one embodiment, the method as above, the first channel comprises a radio link control (RLC) channel between the second terminal device and the third terminal device, and the second channel comprises an RLC channel between the first terminal device and the second terminal device.

In one embodiment, the method as above, the first configuration information or the first configuration feedback information is transmitted through PC5-radio resource control (PC5-RRC) signalling.

The present disclosure provides a method of communication, comprises: receiving, at a third terminal device and from one of a first terminal device and a second terminal device, configuration information indicating a first reconfiguration for a first channel between the second terminal device and the third terminal device; and transmitting, to the one of the first terminal device and the second terminal device, configuration feedback information.

In one embodiment, the method as above, the configuration information is received from the first terminal device and further indicates an end-to-end (E2E) configuration for a bearer between the first terminal device and the third terminal device.

In one embodiment, the method as above, the configuration feedback information indicates at least one of: whether the first reconfiguration is failed, or whether the E2E configuration is failed.

In one embodiment, the method as above, the configuration information or the configuration feedback information is transmitted through PC5-radio resource control (PC5-RRC) signalling.

In one embodiment, the method as above, the configuration information is received from the second terminal device, and wherein the configuration feedback information indicates whether the first reconfiguration is failed.

In one embodiment, the method as above, further comprises: transmitting assistance information to the first terminal device or to the second terminal device, the assistance information indicating at least one of: an identifier of the third terminal device, quality of service (QOS) assistance information, or traffic load information, wherein the assistance information is transmitted through PC5-RRC signalling.

In one embodiment, the method as above, the configuration information or the configuration feedback information is transmitted through at least one of: PC5-RRC signalling, a medium access control (MAC) control element (CE), or sidelink control information (SCI).

In one embodiment, the method as above, the first channel comprises a radio link control (RLC) channel between the second terminal device and the third terminal device.

The present disclosure provides a second terminal device, comprising: a processor; and a memory storing computer program codes; the memory and the computer program codes configured to, with the processor, cause the second terminal device to perform the method implemented at the second terminal device discussed above.

The present disclosure provides a first terminal device, comprising: a processor; and a memory storing computer program codes; the memory and the computer program codes configured to, with the processor, cause the first terminal device to perform the method implemented at the first terminal device discussed above.

The present disclosure provides a third terminal device, comprising: a processor; and a memory storing computer program codes; the memory and the computer program codes configured to, with the processor, cause the third terminal device to perform the method implemented at the third terminal device discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 6-20. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method of communication, comprising:
receiving, at a second terminal device and from a first terminal device, first configuration information indicating at least one of:
a first reconfiguration for a first channel between the second terminal device and a third terminal device, or
at least one quality of service (QOS) parameter for the first channel;
transmitting, to the third terminal device, second configuration information determined based on the first configuration information; and
transmitting, to the first terminal device, configuration feedback information indicating whether the first reconfiguration is failed.

2. The method of claim 1, further comprising:
in accordance with a determination that the first configuration information does not indicate the first reconfiguration for the first channel, generating the first reconfiguration for the first channel based on the at least one QoS parameter;
wherein the second configuration information indicates the first reconfiguration.

3. The method of claim 1, further comprising:
determining that the first reconfiguration is failed in accordance with one of the following:
reception of configuration failure information from the third terminal device,
a maximum number of retries being reached, the retries being performed for retrying reconfiguration of the first channel,
expiry of a first timer being started while transmitting the second configuration information, or
a second reconfiguration for a second channel between the first terminal device and the second terminal device being failed.

4. The method of claim 3, wherein the maximum number of retries is one of the following:
indicated by the first terminal device, wherein the maximum number of retries is determined by the first terminal device or configured by a network device, or
determined by the second terminal device based on the at least one QoS parameter.

5. The method of claim 3, wherein a first time length of the first timer is indicated by the first terminal device or determined by the second terminal device.

6. The method of claim 1, wherein the first configuration information further indicates a second reconfiguration for a second channel between the first terminal device and the second terminal device.

7. The method of claim 6, wherein transmitting the second configuration information comprises:
in accordance with a determination that the second reconfiguration is successful, transmitting the second configuration information.

8. The method of claim 3, wherein the first channel comprises a radio link control (RLC) channel between the second terminal device and the third terminal device, and the second channel comprises an RLC channel between the first terminal device and the second terminal device.

9. The method of claim 1, further comprising:
transmitting the at least one QoS parameter to a serving network device of the second terminal device.

10. The method of claim 1, wherein the at least one QoS parameter comprises at least one of the following:
a PC5 5QI (PQI),
a set of QoS parameters indicating a PQI, a PC5 flow bit rate, a resource type, a priority level, a packet delay budget, a packet error rate, a maximum data burst volume and an averaging window, or
at least one pair of PQI and corresponding application indicated priority.

11. A method of communication, comprising:
transmitting, at a first terminal device and to a second terminal device, first configuration information indicating at least one of:
a first reconfiguration for a first channel between the second terminal device and a third terminal device, or
at least one quality of service (QOS) parameter for the first channel; and
receiving, from the second terminal device, configuration feedback information at least indicating whether the first reconfiguration is failed.

12. The method of claim 11, further comprising:
transmitting, to the second terminal device, an indication comprising at least one of:
a first time length,
multiple time lengths comprising the first time length,
a second time length of a second timer exceeding the first time length, or
a set of time lengths corresponding to a set of terminal devices comprising the first terminal device or the third terminal device,
wherein the indication is comprised in the first configuration information or transmitted separately from the first configuration information.

13. The method of claim 11, wherein the first configuration information further indicates a second reconfiguration for a second channel between the first terminal device and the second terminal device.

14. The method of claim 11, wherein the at least one QoS parameter comprises at least one of the following:
a PC5 5QI (PQI),
a set of QoS parameters indicating a PQI, a PC5 flow bit rate, a resource type, a priority level, a packet delay budget, a packet error rate, a maximum data burst volume and an averaging window, or
at least one pair of PQI and corresponding application indicated priority.

15. A method of communication, comprising:
receiving, at a third terminal device, from a first terminal device or a second terminal device, configuration information indicating a first reconfiguration for a first channel between the second terminal device and the third terminal device; and
transmitting, to the first terminal device or the second terminal device, configuration feedback information.

16. A first terminal device comprising:
a processor; and
a memory storing computer program codes;
the memory and the computer program codes configured to, with the processor, cause the first terminal device to perform the method according to any of claims 11-14.

17. A second terminal device comprising:
a processor; and
a memory storing computer program codes;
the memory and the computer program codes configured to, with the processor, cause the second terminal device to perform the method according to any of claims 1-10.

18. A third terminal device comprising:
a processor; and
a memory storing computer program codes;
the memory and the computer program codes configured to, with the processor, cause the third terminal device to perform the method according to claim 15.

19. A computer readable medium having instructions stored thereon, the instructions, when executed by a processor of an apparatus, causing the apparatus to perform the method according to any of claims 1-15.
